(19) United States
(12) Patent Application Publication
(10) Pub. No.: US 2025/0226869 A1
(43) Pub. Date: Jul. 10, 2025

(54) UCI PROCESSING

(71) Applicant: Samsung Electronics Co., Ltd., Suwon-si (KR)

(72) Inventors: Md. Saifur Rahman, Plano, TX (US); Eko Onggosanusi, Coppell, TX (US); Emad Nader Farag, Flanders, NJ (US)

(21) Appl. No.: 19/007,314

(22) Filed: Dec. 31, 2024

Related U.S. Application Data
(60) Provisional application No. 63/619,697, filed on Jan. 10, 2024.
(60) Provisional application No. 63/565,407, filed on Mar. 14, 2024.

(51) Int. Cl. H04B 7/06

(52) U.S. Cl. CPC H04B 7/0626; H04B 7/0639

(57) ABSTRACT

Apparatuses and methods for uplink control information (UCI) processing. A method performed by a base station (BS) in an open radio access network (O-RAN) architecture includes receiving, by an O-RAN radio unit (O-RU) hosting a low-physical (PHY) layer and radio frequency (RF) processing, an uplink (UL) transmission and decoding, based on the received UL transmission, UCI including channel state information (CSI). The BS further includes an O-RAN distributed unit (O-DU) operably coupled with the O-RU that hosts a high-PHY layer. The low-PHY and high-PHY layers are based on a lower layer functional split of PHY layer baseband functionalities.

### CROSS-REFERENCE TO RELATED AND CLAIM OF PRIORITY

The present application claims priority under 35 U.S.C. § 119 (e) to U.S. Provisional Patent Application No. 63/619,697 filed on Jan. 10, 2024 and U.S. Provisional Patent Application No. 63/565,407 filed on Mar. 14, 2024, which are hereby incorporated by reference in their entirety.

### TECHNICAL FIELD

The present disclosure relates generally to wireless communication systems and, more specifically, the present disclosure is related to apparatuses and methods for uplink control information (UCI) processing.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UCI processing.

In one embodiment, a base station (BS) in an open radio access network (O-RAN) architecture is provided. The BS includes an O-RAN distributed unit (O-DU) hosting a high-physical (PHY) layer and an O-RAN radio unit (O-RU) operably coupled with the O-DU, the O-RU hosting a low-PHY layer and radio frequency (RF) processing. The O-RU comprises a transceiver configured to receive an uplink (UL) transmission and a processor operably coupled with the transceiver. The processor configured to decode, based on the received UL transmission, UCI including channel state information (CSI). The low-PHY and high-PHY layers are based on a lower layer functional split of PHY layer baseband functionalities.

In another embodiment, a method performed by a BS in an O-RAN architecture is provided. The method includes receiving, by an O-RU hosting a low-PHY layer and RF processing, an UL transmission and decoding, based on the received UL transmission, UCI including CSI. The BS further includes an O-DU operably coupled with the O-RU that hosts a high-PHY layer. The low-PHY and high-PHY layers are based on a lower layer functional split of PHY layer baseband functionalities.

In yet another embodiment., a user equipment (UE) communicating with a BS in an O-RAN architecture is provided. The UE includes a transceiver configured to receive information about UCI including CSI and a processor operably coupled with the transceiver. The processor is configured to determine the CSI and encode the UCI, the UCI including the CSI. The transceiver is further configured to transmit an UL transmission including the UCI. The BS comprises an O-DU hosting a high-PHY layer and an O-RU operably coupled with the O-DU, the O-RU hosting a low-PHY layer and RF processing. The low-PHY and high-PHY layers are based on a lower layer functional split of PHY layer baseband functionalities. The O-RU decodes the UCI carrying the CSI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of an example physical layer functionality split according to embodiments of the present disclosure;

FIG. 11 illustrates a diagram of an example framework for a functionality split for DL and UL operations according to embodiments of the present disclosure;

FIG. 12 illustrates a diagram for bit-level and symbol-level processing according to embodiments of the present disclosure;

FIG. 13 illustrates a diagram of example UL functionalities according to embodiments of the present disclosure;

FIGS. 14A and 14B illustrate of example DL functional splits according to embodiments of the present disclosure;

FIG. 15 illustrates another example DL functional split according to embodiments of the present disclosure;

FIGS. 16A and 16B illustrate of example UL functional splits according to embodiments of the present disclosure;

FIG. 17 illustrates a diagram of potential issues with RU and DU functionality splits;

FIG. 18 illustrates an example of an antenna port layout and antenna/port group (PG) according to embodiments of the present disclosure;

FIG. 19 illustrates an example of channel dimensionalization according to embodiments of the present disclosure;

FIG. 20 illustrates an example of an analog beam-based NW topology according to embodiments of the present disclosure;

FIG. 21 illustrates an example of PG or O-RU (or RU)-based mobility according to embodiments of the present disclosure;

FIG. 22 illustrates an example of PG or O-RU (or RU) selection hypotheses according to embodiments of the present disclosure;

FIG. 23 illustrates a diagram of an example functional split between a DU an RU for uplink and downlink communications according to embodiments of the present disclosure;

FIG. 24 illustrates a diagram for an example comparison between O-RAN Cat-C and the flash O-RU (Cat-D split) according to embodiments of the present disclosure;

FIG. 25 illustrates a diagram of an example functional split for processing an UL transmission according to embodiments of the present disclosure;

FIG. 26 illustrates four examples of types of functional splits for processing of the UL transmission;

FIG. 27 illustrates a diagram of example inter O-RU direct access/communication links according to embodiments of the present disclosure; and

FIG. 28 illustrates an example method performed by a BS in an O-RAN architecture according to embodiments of the present disclosure.

### DETAILED DESCRIPTION

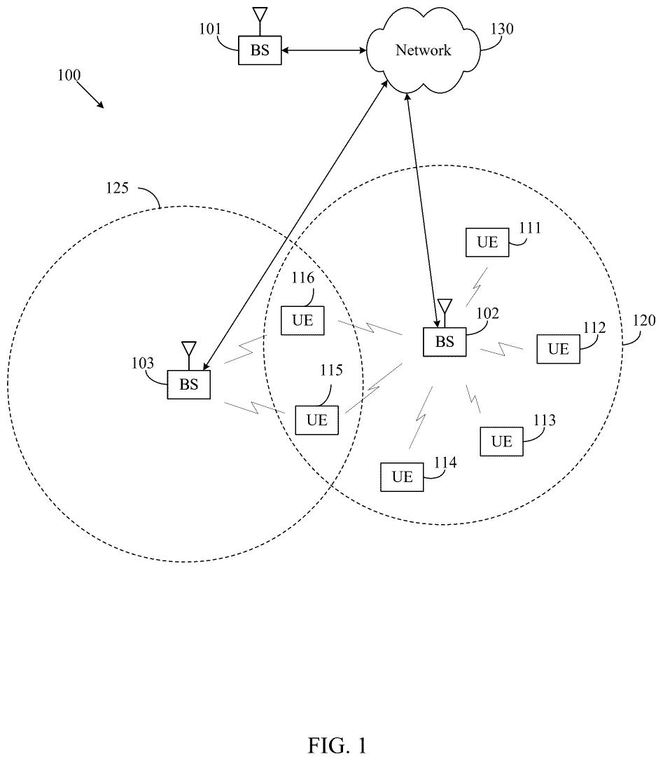

FIGS. 1-28 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 36.211 v17.3.0, “E-UTRA, Physical channels and modulation;” [REF2] 3GPP TS 36.212 v17.3.0, “E-UTRA, Multiplexing and Channel coding;” [REF3] 3GPP TS 36.213 v17.3.0, “E-UTRA, Physical Layer Procedures;” [REF4] 3GPP TS 36.321 v17.3.0, “E-UTRA, Medium Access Control (MAC) protocol specification;” [REF5] 3GPP TS 36.331 v17.3.0, “E-UTRA, Radio Resource Control (RRC) Protocol Specification;” [REF6] 3GPP TR 22.891 v1.2.0; [REF7] 3GPP TS 38.212 v18.0.0, “E-UTRA, NR, Multiplexing and Channel coding;” [REF8] 3GPP TS 38.214 v18.0.0, “E-UTRA, NR, Physical layer procedures for data;” [REF 9] 3GPP TS 38.211 v18.0.0, “E-UTRA, NR, Physical channels and modulation;” [REF10] 3GPP TS 38.104 v18.3.0, “E-UTRA, NR, Physical channels and modulation;” [REF11] O-RAN.WG4.CONF.0-R003-v09.00, “O-RAN Working Group 4 (Fronthaul Working Group) Conformance Test Specification;” and [REF12] O-RAN.WG4.CUS.0-R003-v13.00, “O-RAN Working Group 4 (Open Fronthaul Interfaces WG)-Control, User and Synchronization Plane Specification.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, As described in more detail below, one or more of the UEs 111-116 include circuitry, programing, or a combination thereof transmitting UCI for processing. Additionally, one or more of the BSs 101-103 include circuitry, programing, or a combination thereof for UCI processing.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

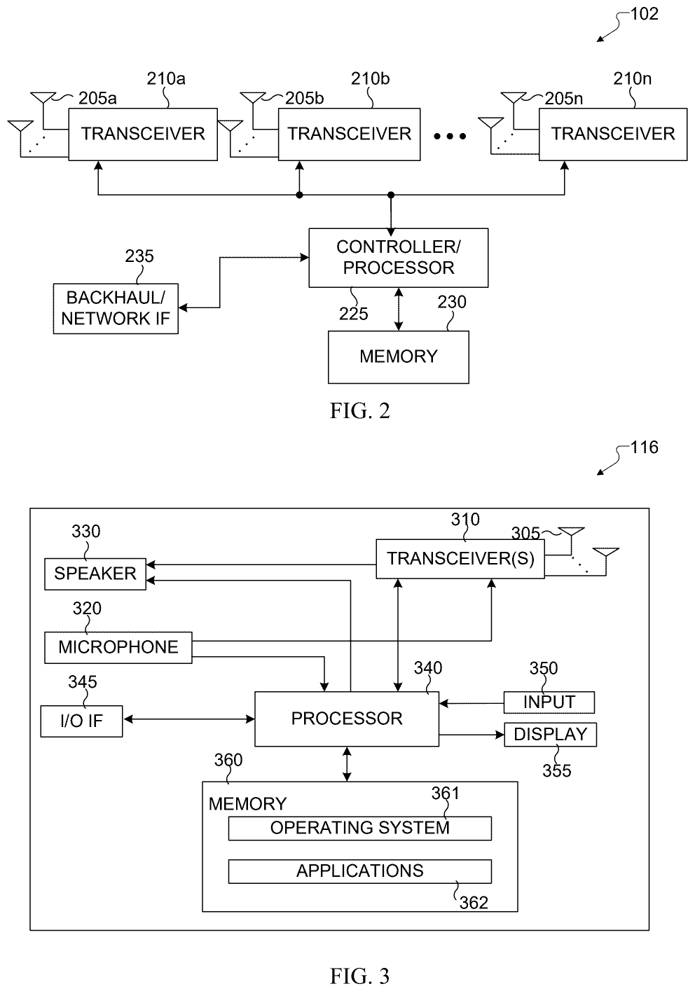

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UCI processing. Any of a wide variety of other functions could be supported in the gNB 102 by the controller/processor 225.

The controller/processor 225 is also capable of executing programs and other processes resident in the memory 230, such as processes for UCI processing. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for transmitting UCI for processing. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

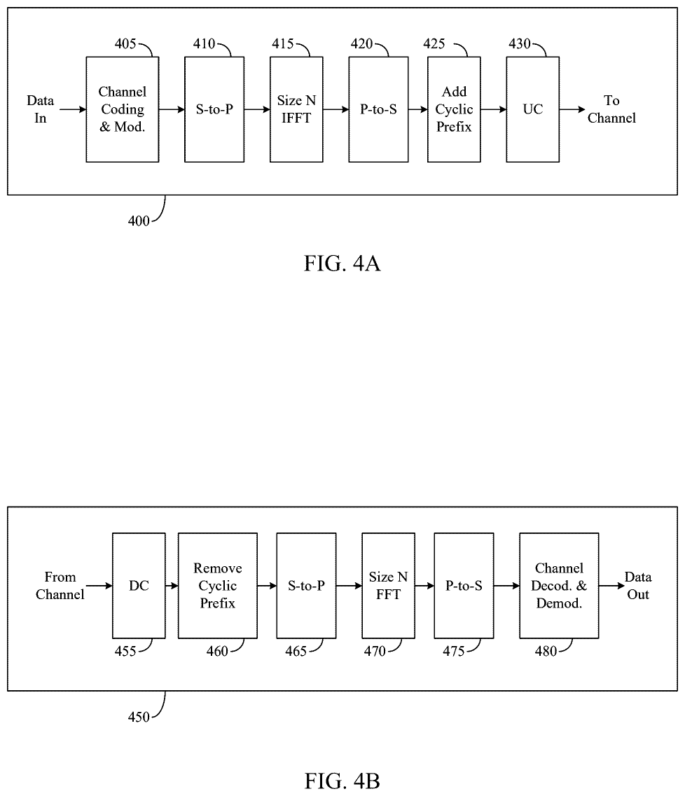

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured for UCI processing as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The P-to-S block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

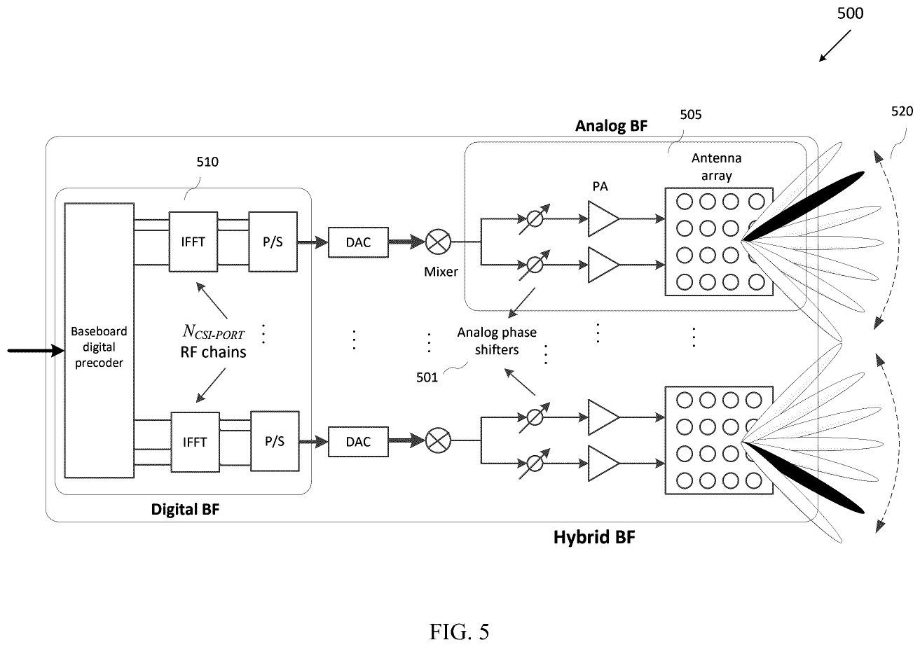

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port.

In a hybrid analog-digital beamforming, analog beamforming corresponds to a ‘dynamic/varying’ virtualization of multiple antenna elements to obtain one antenna port (or antenna panel). Although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. In this case, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam.

The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to UCI processing for next generation of communication (e.g. 6G) systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB) or gNodeB (gNB), which is generally a fixed station, may also be referred to as an access point or other equivalent terminology. For LTE systems, a NodeB is often referred to as an eNodeB. For NR systems, a NodeB is often referred to as an gNodeB.

In a communication system, such as NR or LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS for time/frequency tracking (aka CRS in LTE or TRS in NR), for CSI reporting. DMRS can be transmitted only in the BW of a respective PDSCH, and a UE can use the DMRS to demodulate data or control information in a PDSCH or a PDCCH, respectively. A transmission time interval for DL channels is referred to as a subframe or slot and can have, for example, duration of 1 millisecond or a value depending on the subcarrier-spacing (SCS).

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)-see also REF 3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical Resource Blocks (PRBs). A transmission BW includes frequency resource units referred to as Resource Blocks (RBs). Each RB includes NRB Vsc sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}. N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data transport block (TB) in a PDSCH or absence of a PDCCH detection (DTX), Scheduling Request (SR) indicating whether a UE has data in its buffer, and Channel State Information (CSI) enabling an eNB/gNB to perform link adaptation for PDSCH transmissions to a UE. HARQ-ACK information is also transmitted by a UE in response to a detection of a PDCCH indicating a release of semi-persistently scheduled PDSCH (see also REF 3).

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}. N_{sc}^{RB} REs for a transmission BW. A last few subframe (or slot) symbols can be used to multiplex SRS transmissions from one or more UEs. A number of subframe (or slot) symbols that are available for data/UCI/DMRS transmission is N_{symb}=2. (N_{symb}^{UL}−1)−N_{SRS}, where N_{SRS}=1 if a last subframe (or slot) symbol is used to transmit SRS and N_{SRS}=0 otherwise.

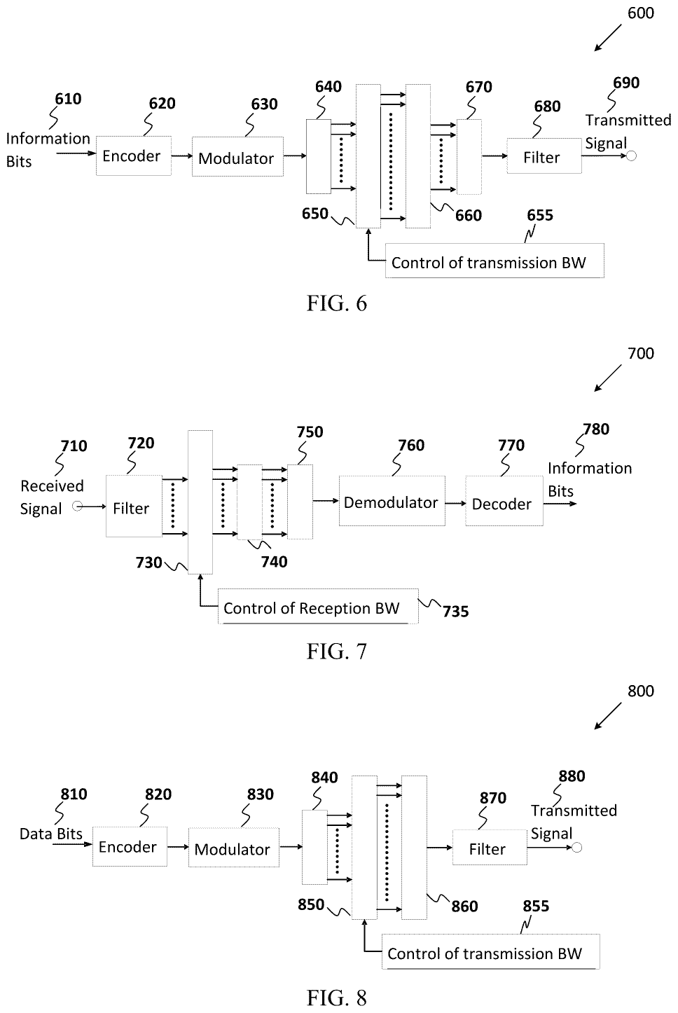

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

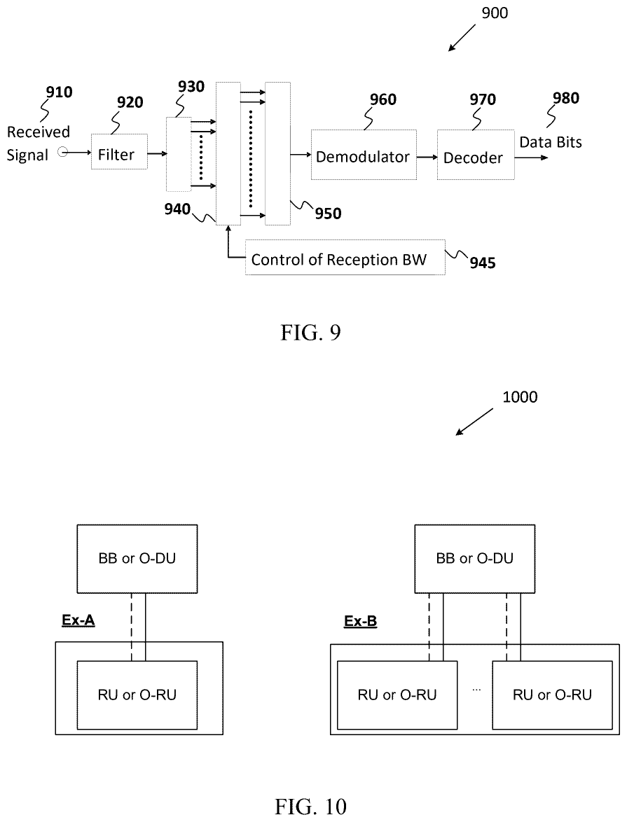

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range designation | Corresponding frequency range |
|---|---|
| FR1 | 450 MHz-600 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be evaluated, e.g., FR4 (>52.6 GHZ), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW (e.g., the network 130) deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of radio RF/hardware (HW)-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In next generation cellular standards (e.g. 6G), in addition to FR1 and FR2, new carrier frequency bands are used, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed regarding carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiuser MIMO (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHZ) band, the NW topology/architecture is likely to be more and more distributed in the future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to the distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

FIG. 10 illustrates a diagram of example physical layer functionality split 1000 according to embodiments of the present disclosure. For example, the physical layer functionality split 1000 can be implemented by the BS 102 of FIG. 2. This example is for illustration only and other embodiments can be used without departing from the scope of the present disclosure.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, or a cell group.

Likewise, for O-RAN, a TRP can be functionally equivalent to (hence can be replaced with) or is interchangeable with one of more of the following:
One receiver unit (RU) or O-RU: a logical node that includes a subset of the eNB/gNB functions (e.g. as listed in clause 4.2 split option 7-2x)
More than one RUs or O-RUs
One or more than one RUs or O-RUs

With reference to FIG. 10, two examples are shown. In example A, the BS (e.g., BS 102) includes a functional split with certain activities performed at the baseband or O-DU and certain activities performed by the RU or O-RU, which are connected by a fronthaul (FH) which may include wired or wireless links. In example B, the BS (e.g., BS 102) includes the same functional split between the baseband or O-DU and the RU or O-RU, but includes multiple RUs or O-RUs, which are each connected by a FH link to the baseband or O-DU. In these examples, each of the DU and RU may include a processor, such as processor 225, while the RU includes transceiver(s) and antenna(s), such as transceiver(s) 210a-210n and antenna(s) 205a-205n, for communicating over RF to various UEs in a wireless network.

The following are defined in [REF11] and [REF12].

| | |
|---|---|
| O-CU | O-RAN Central Unit - a logical node hosting packet data convergence protocol |
| | (PDCP), RRC, service data adaptation protocol (SDAP) and other control |
| | functions |
| O-DU | O-RAN Distributed Unit: a logical node hosting RLC/MAC/High-PHY layers |
| | based on a lower layer functional split. O-DU in addition hosts an M-Plane |
| | instance. |
| O-RU | O-RAN Radio Unit: a logical node hosting Low-PHY layer and RF processing |
| | based on a lower layer functional split. This is similar to 3GPP's “TRP” or “RRH” |
| | but more specific in including the Low-PHY layer (FFT/iFFT, physical random |
| | access channel (PRACH) extraction).>. O-RU in addition hosts M-Plane instance. |

A legacy up to 5G network (NW) can be described in terms of transmit-receive points (TRPs). For a first frequency range (FR1), i.e., <6 GHz, a TRP can comprise one or more antenna ports, and is fully-digital (i.e. each antenna port is driven by a dedicated baseband processing chain); and for a second frequency range 24.25-52.6 GHZ (FR2), i.e., for mmWave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mmWave frequencies, each antenna panel requires dynamic/frequent update of the analog BF, which is often based on (analog) beam measurement and reporting.

A communication between the 5G NW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=Nsym consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g. RSRP, SINR).

For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-) MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Assuming NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

A transmission configuration indication (TCI) framework is shared between (non-beam-related) CSI and beam management (BM). While the complexity of such a TCI framework is justified for CSI acquisition in FR1, it makes BM procedures less efficient in FR2. Furthermore, the BM procedures can be different for different channels due to their different target scenarios. Having different beam indication/update mechanisms increases the complexity, overhead, and latency of BM. Such drawbacks are especially troublesome for high mobility scenarios (such as highway and high-speed train). These drawbacks motivated a streamlined BM framework for beam-based operations and procedures that is common for data and control, and uplink (UL) and downlink (DL) channels. This framework is referred to as a unified TCI (uTCI) framework, firstly introduced for sTRP and now being enhanced for mTRP.

The uTCI framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

Advanced features: The uTCI framework can support a beam-level mobility, known as inter-cell BM (ICBM). In ICBM, the user-dedicated channels can be configured to use a beam (i.e., TCI state) associated with a (non-serving) cell having a physical cell identity (PCI) that is different from the PCI of the serving cell. This allows fast beam-switch to a non-serving cell for user-dedicated channels at a lower layer without involving a higher layer and without incurring latency and overhead of handover.

The ICBM is being further enhanced to support a complete cell-switch triggered by lower layers, which is known as lower-layer triggered mobility (LTM). In LTM, the NW can acquire beam measurements, and UL timing information for target candidate cells before cell-switch. The lower layers of the NW decide when to perform a cell-switch, and send a medium access control channel element (MAC CE) containing a cell-switch command (CSC) that triggers the cell-switch from a source cell to a target cell. The CSC includes beam (i.e., TCI state) and UL timing information for the user to use on the target cell. After a beam application delay, the user and the NW communicates via the target cell.

NW energy saving (NES) is another advanced feature, wherein the NW can optimize energy usage by turning TRPs ON/OFF, thereby saving power. From a user's perspective, this is akin to dynamic SD resource update between transmissions. The CSI in the NES scenario can be based on multiple sub-configurations, each corresponding to different SD resource assignments, and dynamically (via DCI) triggering one or multiple of the sub-configurations for CSI reporting.

Full-duplex transmission and reception in the same NR channel BW or using non-contiguous intra-band carrier aggregation (CA) is a promising technology to enhance UL coverage, reduce latency and improve system capacity and to overcome limitations inherent to the use of de-facto mandated semi-static TDD UL-DL frame configurations in today's NR TDD deployments. Currently, 3GPP is studying benefits, feasibility and deployment scenarios for enabling NW-side full-duplex operation where simultaneous transmissions and receptions by the NW on the same time-domain symbol on the NR carrier can only occur in non-overlapping UL and DL subbands, e.g., subband full-duplex (SBFD) mode. In this first step of NR duplex evolution, users with support for NW-side SBFD operation still operate in half-duplex, i.e., the user can either transmit or receive on an SBFD symbol but not transmit and receive simultaneously. An SBFD UL subband can be located in the center or at the edge of the NR carrier in FR1 or FR2-1. For CA-based SBFD in FR2-1, one component carrier (CC) is allocated for UL transmissions whereas the remaining CCs are used for DL transmission.

NW-side self-interference cancellation (SIC) capability to enable SBFD can be realized through a combination of solutions. For example, the NW can use Tx/Rx antenna isolation on the antenna panel(s), beam steering, analog and/or digital pre-distortion, digital interference cancellation, and analog and/or digital filtering solutions. Note that passive Tx/Rx antenna isolation has been demonstrated to achieve in excess of 80 dB in FR1 with even higher isolation in FR2-1. For example, SBFD for the Local Area base station class characterized by small Tx power and reduced Rx sensitivity can already achieve a significant amount of SIC capability by relying on antenna isolation alone. Wide Area base stations characterized by much higher transmit power and higher Rx sensitivity may need to implement a more extensive set of solutions to support SBFD.

NW-side SBFD operation can be enabled transparently for legacy NR users and has been shown feasible and providing gains. In this case, legacy users are scheduled UL transmissions in the SBFD UL subband of the NR carrier on symbols configured as flexible by SIB1. More gains in the NR TDD cell supporting NW-side SBFD operation can be achieved in presence of SBFD-aware users, e.g., supporting resource allocation enhancements for PDSCH, PUSCH and PUCCH including handling of TCI states and BF, and CSI reporting enhancements to best exploit the link conditions on SBFD and non-SBFD slots/symbols on the serving cell.

As explained, the 5G NW can support several features, services, use cases, and deployment scenarios. It however also introduces too many different abstractions (for specification) of NW entities and involved signaling for components of these abstractions. For instance, the specification supports abstractions for single-cell, multi-cell, sTRP, mTRP, panel, antenna panel, antenna port, resource, resource set, and beam; and signaling for a complicated CSI framework based on components such as CSI resource setting (one or more CSI-RS resources sets, each with one or more CSI-RS/SSB resources) and CSI report setting that links a CSI resource setting to a report quantity from a set of multiple supported report quantities, wherein a report quantity can correspond to beam report (i.e. an analog beam and a beam quality) or a non-beam report (i.e. RI/CQI/PMI/CRI). In addition, for PMI, too many different codebooks are supported. Due to these reasons, deployment of the 5G NW is challenging in reality. A direct scaling/extension/reuse of these legacy up to 5G solutions for 6G will add to the complexity, which is undesired in real NW deployments.

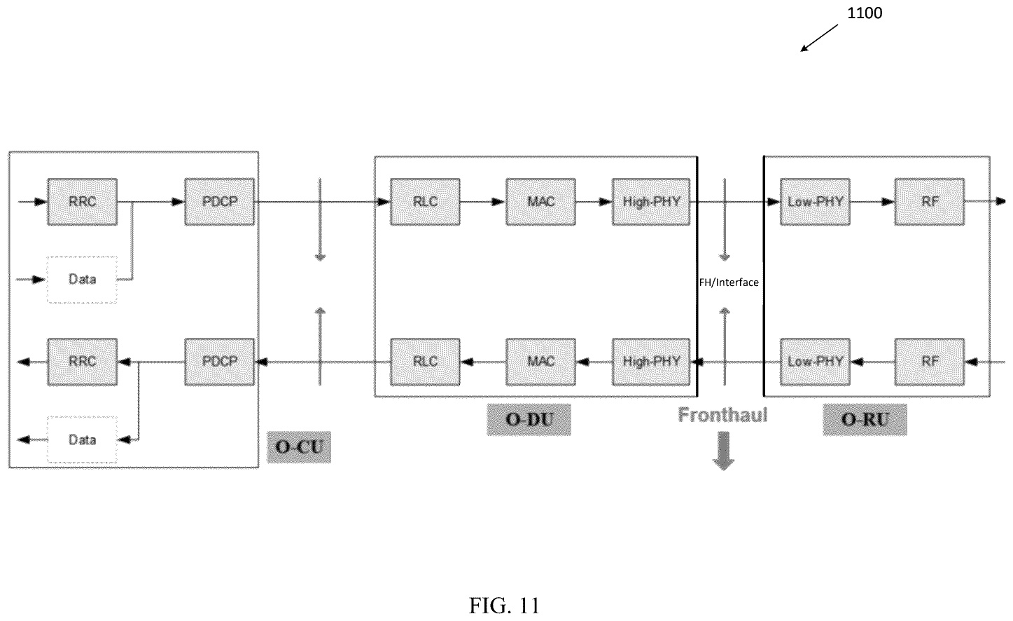

FIG. 11 illustrates a diagram of example framework 1100 for a functionality split for DL and UL operations according to embodiments of the present. For example, the framework 1100 can be implemented in the BS 102 of FIG. 2. This example is for illustration only and other embodiments can be used without departing from the scope of the present disclosure.

As illustrated in FIG. 11 and discussed above, data, RRC, and PDCP functionalities are performed at the O-CU. RLC, MAC, and high-PHY functionalities are performed at the O-DU. Low-PHY and RF functionalities are performed at the O-RU.

In 6G:
(A) one key (essential) aspect can be a basic building block (in terms of NW architecture), which is as streamlined/simple as possible.
(B) another key aspect is the functionality split for DL and UL operations, such as O-RU, O-DU, and O-CU (as described above). An example is shown in FIG. 11. In particular, the PHY functionality split between O-DU and O-RU provides for the following aspects.
   (B1) PHY processing:
      bit-level processing,
      symbol-level processing
   (B2) Scheduling: SU/MU across different O-RUs or/and PRBs/PRGs/SBs
      Based on UCI carrying CSI.
      SRS channel measurement
   (B3) Precoder calculation:
      For SU: precoder calculation can be simply followed the precoder based on CSI report (UCI carrying CSI).
      For MU, precoder (e.g. ZF, SLNR) needs to be calculated based on the CSI report (or channel measurement) for co-scheduled UEs.

The first (A) can be achieved by removing/merging duplicate/redundant abstractions, and simplifying signaling for components of the abstractions. One such framework, namely dynamic MIMO, is provided in this disclosure, wherein abstractions such as CSI-RS resource, CSI-RS resource set, port, beam, TRP, panel etc. can all be clubbed into one basic entity, namely antenna/port group (PG or O-RU (or RU)), and essential features of PGs are specified. A few essential features discussed include dynamic PG or O-RU (or RU) selection and long-term stats and assumptions across PGs, e.g., quasi co-location (QCL) and coherency relationships across PGs. The provided framework can also facilitate fast and accurate CSI acquisition, where the CSI can be beam-related (e.g. beam indicator, beam metric), non-beam-related (e.g. RI/PMI/CQI), or both. Additionally, the concept of a cell is replaced with PGs that are distributed through the NW. The mobility can be handled via the PG or O-RU (or RU) selection/update (from one set of PGs to another set of PGs).

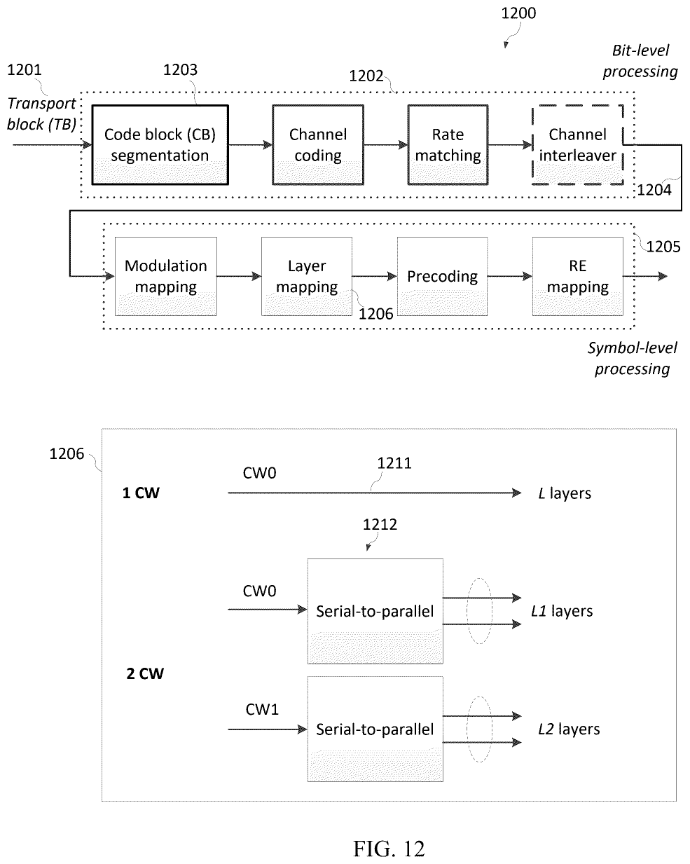

FIG. 12 illustrates a diagram for bit-level and symbol-level processing 1200 according to embodiments of the present disclosure. For example, the bit-level and symbol-level processing 1200 can be implemented by the BS 102 of FIG. 2. This example is for illustration only and other embodiments can be used without departing from the scope of the present disclosure.

As illustrated in FIG. 12, a transport block (TB) 1201 is processed by the following series of bit-level operations 1202: code block (CB) segmentation (step 1203), channel coding, rate matching, and channel interleaver (only for UL). For CB segmentation, a length-LTB TB is segmented into C≥1 CBs if LTB>6144. If C=1, only a 24-bit TB-CRC is inserted. If C>1, a 24-bit TB-CRC is first added before CB segmentation, followed by the insertion of a 24-bit CB-CRC at the end of each CB. Therefore, for C>1, both TB-CRC and CB-CRC are inserted. Note that TB-CRC and CB-CRC have different generating polynomials. To minimize the number of filler bits, up to two values of CB length K+ and K− are used. Therefore, in most cases when C>1, some CBs can be of length-K while the others of length-K+. For channel coding, a set of allowable CB lengths (defined for Turbo QPP interleaver) are used with rate-1/3 Turbo code (PCCC) with 8-state constituent encoders. Since Turbo code is based on convolutional code, it does not have a built-in error detection capability. For rate matching, equal interleaving & puncturing for each of 3 Turbo output streams. This is achieved using 3 identical rectangular sub-block interleavers (one interleaver per Turbo output stream), bit collection followed by bit selection/pruning via circular buffer, and CB concatenation to form codeword (CW).

The output of bit-level processing 1204, associated with one TB and one CW, is then processed by the following series of symbol-level operations 1205: modulation mapping, layer mapping (1206), precoding, and RE mapping. Depending on the number of transmission layers, one or more than one CWs are used for DL and UL data transmissions (on DL data channel such as PDSCH or PDCCH, and UL data channel such as PUSCH or PUSCH, respectively) for spatial multiplexing. In the figure, two examples of shown for 1 CW, L layers 1211 and 2 CWs, L1+L2 layers 1212.

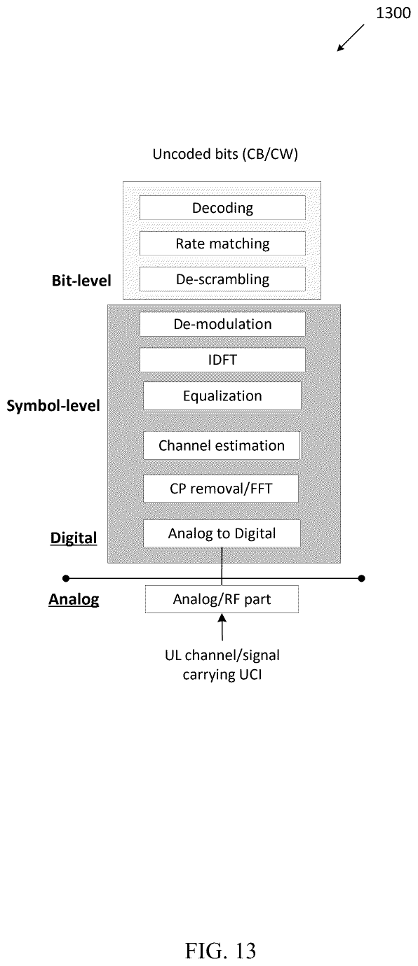

FIG. 13 illustrates a diagram of example UL functionalities 1300 according to embodiments of the present disclosure. For example, the UL functionalities 1300 can be implemented by the BS 102 of FIG. 2. This example is for illustration only and other embodiments can be used without departing from the scope of the present disclosure.

As illustrated in FIG. 13, the analog processing includes receipt of an UL channel/UCI. The digital symbol-level processing includes analog to digital conversion, CP removal/FFT, channel estimation, equalization, IDFT, and de-modulation. The digital bit-level processing includes de-scrambling, rate matching, and decoding to generate uncoded bits, such as a code block or codeword.

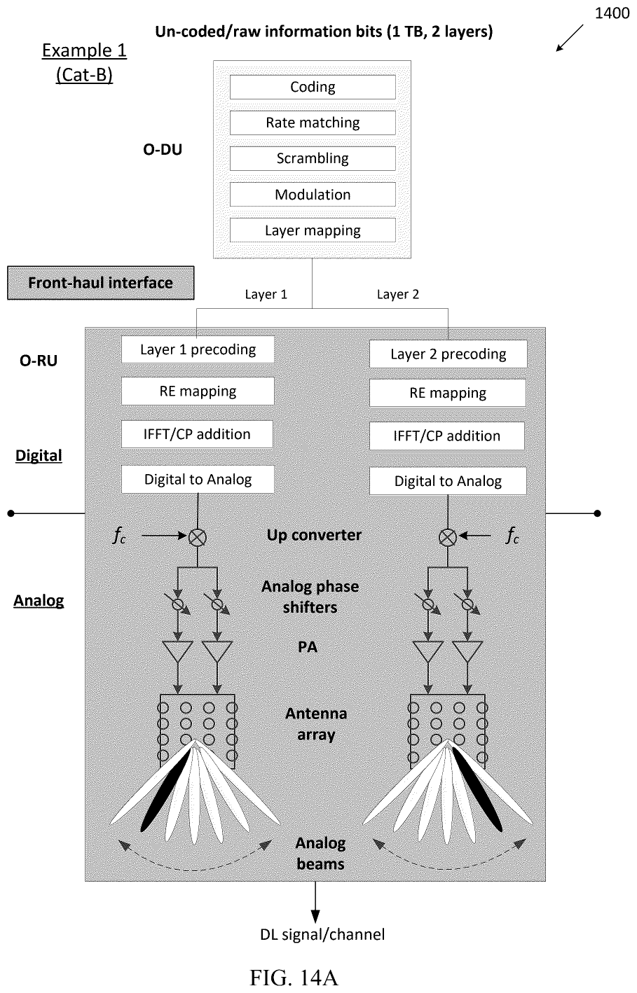

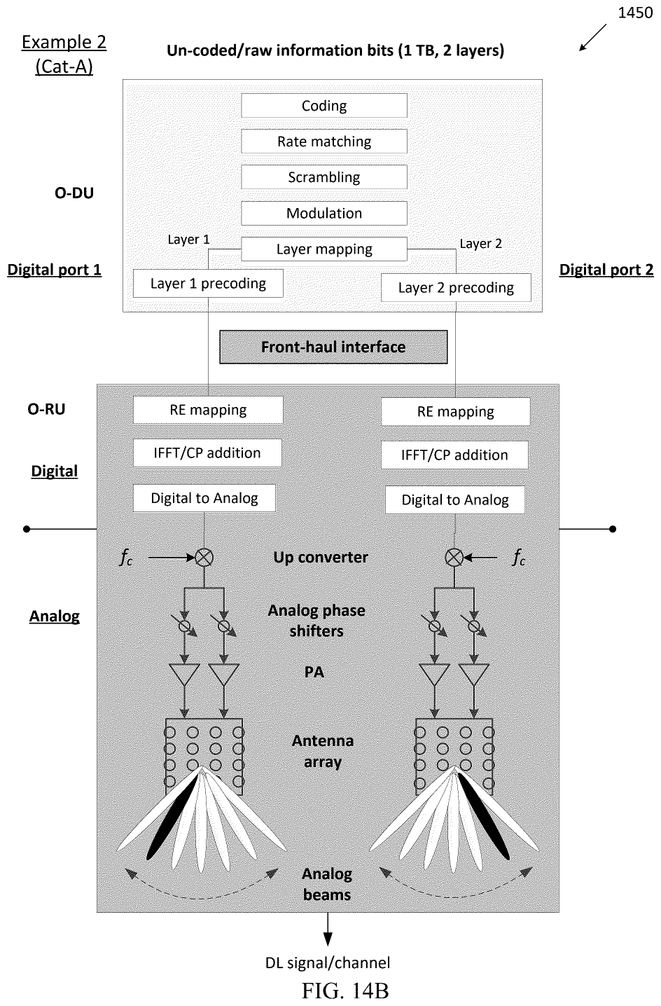

FIGS. 14A and 14B illustrate example DL functional splits 1400 and 1450 according to embodiments of the present disclosure. For example, the DL functional splits 1400 and 1450 can be implemented by the BS 102 of FIG. 2. This example is for illustration only and other embodiments can be used without departing from the scope of the present disclosure.

As illustrated in FIGS. 14A and 14B, two examples of (O-DU, O-RU) functionality split for DL are shown. In FIG. 14B, example 2 (Cat-A) performs precoding in O-DU and in FIG. 14A, example 1 (Cat-B) in O-RU. Here, the FH throughput requirement scales with the number of antenna ports for Example 2 and with the number of layers for Example 1. Example 2 therefore can exceed the FH capacity, especially for large number of ports. Therefore, Example 1 is a preferred PHY split for DL in some embodiments.

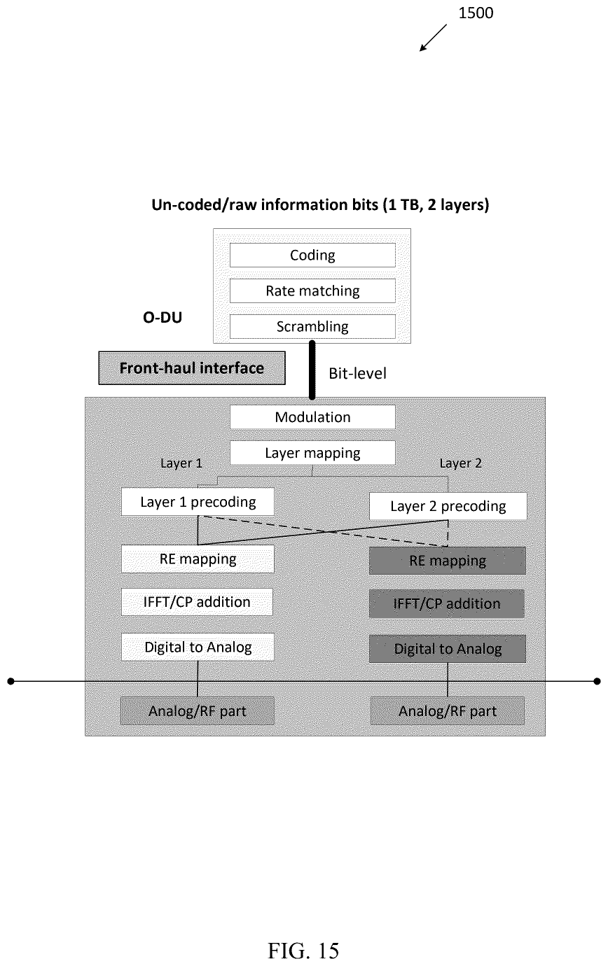

FIG. 15 illustrates another example DL functional split 1500 according to embodiments of the present disclosure. For example, the DL functional split 1500 can be implemented by the BS 102 of FIG. 2. This example is for illustration only and other embodiments can be used without departing from the scope of the present disclosure. In this example, the modulation and layer mapping functionalities are performed by the O-RU.

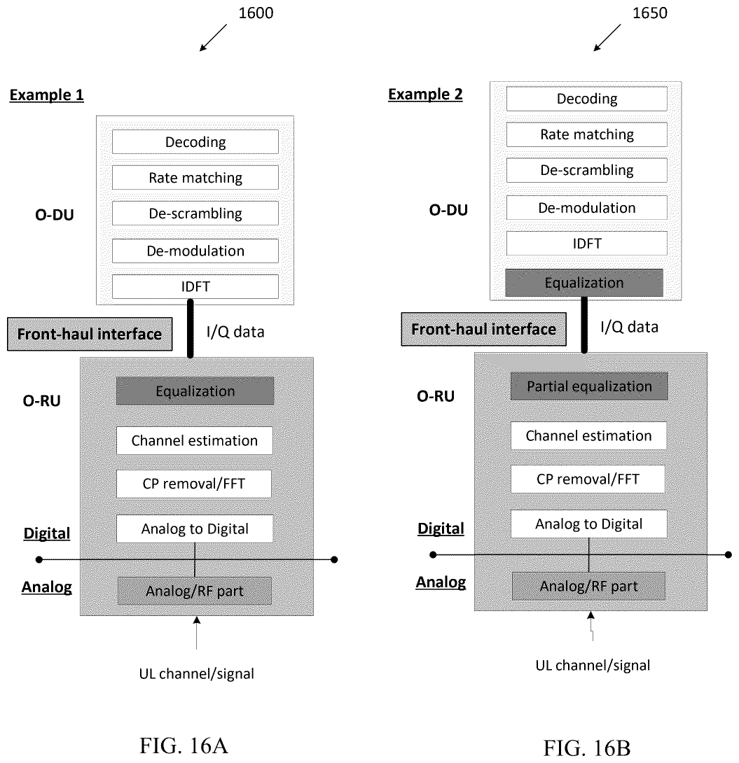

FIGS. 16A and 16B illustrate example UL functional splits 1600 and 1650 according to embodiments of the present disclosure. For example, the DL functional splits 1600 and 1650 can be implemented by the BS 102 of FIG. 2. This example is for illustration only and other embodiments can be used without departing from the scope of the present disclosure.

Two examples of O-DU, O-RU functionality split (Cat-C) for UL are shown in FIGS. 16A and 16B. In both examples the PHY split facilitates channel estimation with equalization (full vs partial) in O-RU, which are beneficial for UL.

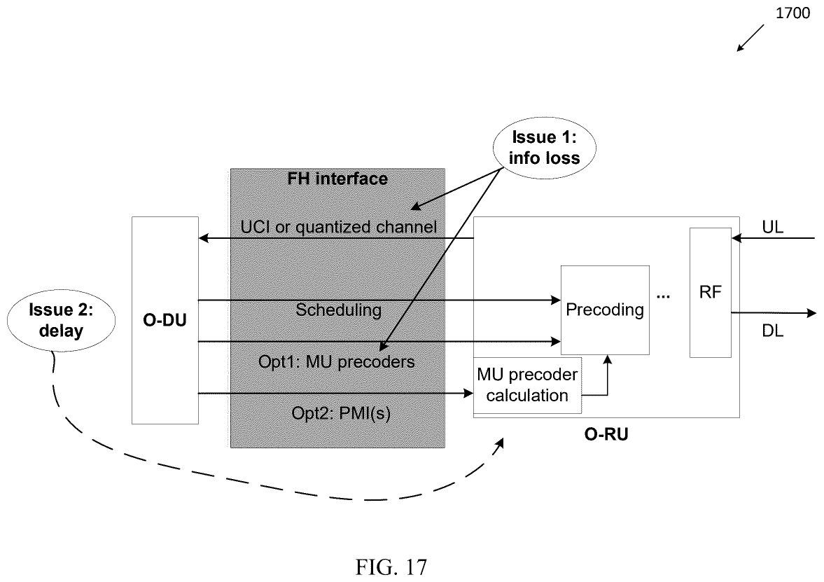

FIG. 17 illustrates a diagram of potential issues with RU and DU functionality splits 1700. This example is for illustration only.

Embodiments of the present disclosure recognize and take into consideration that the following issues, if unaddressed, can result in severe implications particularly on DL MIMO schemes (e.g. MU-MIMO, CJT, high-resolution SVD-based precoding), that the promised gains of such schemes can vanish:
Issue 1 (accuracy loss due to FH compression/decompression): the UL I/Q samples and SRS-based channel measurement are first quantized and then transferred to the O-DU over a FH interface. For DL precoding, the scheduling and precoding information need to be provided to the respective O-RU(s) by the scheduler in the MAC residing in the O-DU (where precoding is calculated). The precoding information is further quantized prior to transfer over the FH interface. This twofold quantization incurs twofold SNR loss (hence inaccuracy) to the precoder to be applied in O-RU(s). This is especially severe for MU-MIMO or SRS-/reciprocity-based precoder calculated using SVD since SVD is known to be extra sensitive to any impairment.
Issue 2 (round-trip delay due to information exchange between O-RU and O-DU): as described in Section 5, the round-trip delay (O-RU to O-DU and O-DU to O-RU) can be large (e.g. from a few symbols to a few slots) depending on the distance between the O-DU and O-RU(s), as well as the underlying communication protocol (e.g., Ethernet adds a high latency). This latency adds to additional CSI impairments thereby reducing system throughput and reliability.

These issues are illustrated in FIG. 17. Here, an UL signal passes RF and lower PHY operations in O-RU. The resultant I/Q symbols and SRS measurement are quantized before transmitting over the FH interface. The received signal is de-quantized then passed on to the O-DU, which performs high PHY operations to extract information bits including UCI carrying PMI(s). The MAC in O-DU then performs scheduling, and communicates the scheduling and corresponding precoding information (Opt1: MU precoders or Opt2: PMI(s)) after quantization over the FH interface to relevant O-RU(s).

To remedy or address one or more of the above issues (thereby providing better massive MIMO performance), embodiments of the present disclosure provide improvements to the O-RU.

Embodiments of the present disclosure relates to next generation MIMO systems (e.g. adv. 5G and 6G). In particular, it relates to a (A) dynamic MIMO operations based on a single basis entity, namely antenna/port group (PG), that can be useful for a wide range of applications such as traditional MIMO (FR1), beam-formed MIMO (FR2 and beyond), dynamic port assignment for network energy saving and duplexing operations, predictive MIMO (mobility scenarios) etc; and (B) functional split DL and UL functionalities (O-RU, O-CU, O-CU) (cf. O-RAN). In particular, embodiments of the present disclosure provide for UL functional splits for the case when the UL channel/signal carries UCI. In some embodiments, different examples of functional splits for the case when the UL channel/signal carries UCI are provided. In some embodiments, functional splits are based on bit-level or/and symbol-level processing/modules. In some embodiments, functional splits are based on two part of bit-level or symbol-level processing/module (e.g. for CSI, demodulation, etc.).

In the following, for brevity, both FDD and TDD are considered as the duplex method for both DL and UL signaling. Although exemplary descriptions and embodiments to follow assume orthogonal frequency division multiplexing (OFDM) or orthogonal frequency division multiple access (OFDMA), embodiments of the present disclosure can be extended to other OFDM-based transmission waveforms or multiple access schemes such as filtered OFDM (F-OFDM). This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

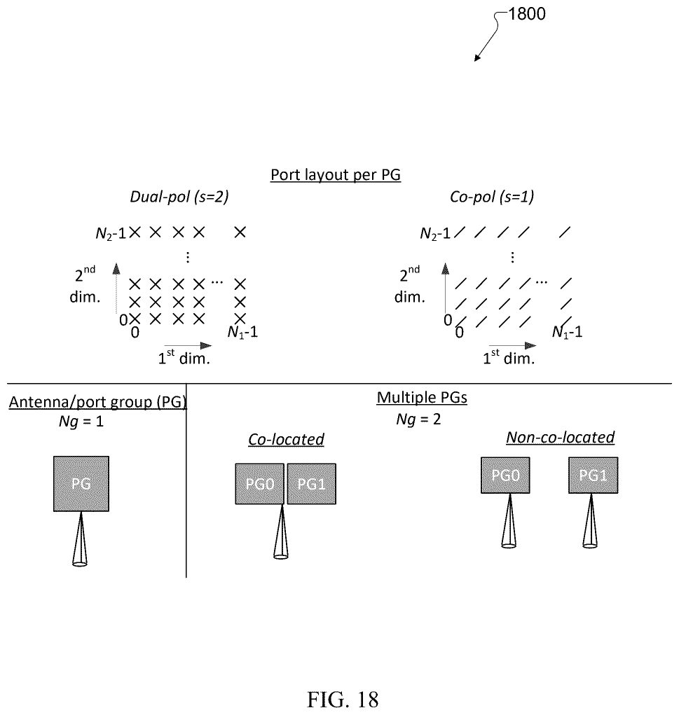

FIG. 18 illustrates an example of an antenna port layout and antenna/PG 1800 according to embodiments of the present disclosure. For example, the antenna port layout and antenna/PG 1800 can be implemented by in the network 100 of FIG. 1. This example is for illustration only and other embodiments can be used without departing from the scope of the present disclosure.

Regarding antenna/PGs, N₁ and N₂ are the number of antenna ports with the same polarization in the first and second dimensions, respectively. For 2D antenna port layouts, N₁>1, N₂>1, and for 1D antenna port layouts, N₁>1 and N₂=1 or N₂>1 and N₁=1. In the rest of the disclosure, 1D antenna port layouts with N₁>1 and N₂=1 are discussed. The present disclosure, however, is applicable to the other 1D port layouts with N₂>1 and N₁=1. Also, in the rest of the present disclosure, N₁>N₂. The present disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is PCSIRS=N₁N₂. And, for a dual-polarized antenna port layout, the total number of antenna ports is PCSIRS=2N₁N₂. An illustration is shown in FIG. 18 where “X” represents two antenna polarizations (dual-pol, s=2) and “/”′ represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where PCSIRS is a number of CSI-RS antenna ports and X is a starting antenna port number (e.g. X=3000, then antenna ports are 3000, 3001, 3002, . . . ). Unless stated otherwise, dual-polarized antenna layouts are assumed in this disclosure. The embodiments (and examples) in this disclosure however are general and are applicable to single-polarized antenna layouts as well.

Let s denote the number of antenna polarizations (or groups of antenna ports with the same polarization). Then, for co-polarized antenna ports, s=1, and for dual- or cross (X)-polarized antenna ports s=2. So, the total number of antenna ports PCSIRS=SN₁N₂.

Let N_{g} be a number of antenna/port groups (PGs). When there are multiple antenna/port groups (N_{g}>1), each group (g ∈{1, . . . , N_{g}}) is assumed to comprise N_{1,g} and N₂,g ports in two dimensions. This is illustrated in FIG. 18. Note that the antenna port layouts may be the same (N_{1,g}=N₁ and N₂,g=N₂) in different antenna/port groups, or they can be different across antenna/port groups. For group g, the number of antenna ports is PCSIRS,g=N_{1,g}N_{2,g} or 2N_{1,g}N_{2,g} (for co-polarized or dual-polarized respectively), i.e., PCSIRS,g=SgN_{1,g}N_{2,g} where Sg=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-) configured more dynamically (e.g. via MAC CE or/and DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 18. The antenna structure at each PG or O-RU (or RU) can be the same. Or the antenna structure at an PG or O-RU (or RU) can be different from another PG or O-RU (or RU). Likewise, the number of ports at each PG (or O-RU or RU) can be the same. Or the number of ports at one PG (or O-RU or RU) can be different from another PG (or O-RU or RU).

In another example, the antenna architecture of the MIMO system is unstructured. For example, the antenna structure at one PG (OR O-RU OR RU) can be different from another PG (OR O-RU OR RU).

A structured antenna architecture is assumed in the rest of the disclosure. For simplicity, each PG (or O-RU or RU) is assumed to be equivalent to a panel (cf. FIG. 18), although, an PG (or O-RU or RU) can have multiple panels in practice. The disclosure however is not restrictive to a single panel assumption at each PG (or O-RU or RU), and can easily be extended (covers) the case when an PG (or O-RU or RU) has multiple antenna panels.

In one embodiment, an PG (or O-RU or RU) constitutes (or corresponds to or is equivalent to) at least one of the following:

In one example, an PG or O-RU (or RU) corresponds to a TRP.

In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained earlier in this disclosure.

In one example A.3, an PG or O-RU (or RU) corresponds to a CSI-RS resource group, where a group comprises one or multiple NZP CSI-RS resources. A UE is configured with K≥ N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained earlier in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.

In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.

In one example, an PG or O-RU (or RU) corresponds to examples herein depending on a configuration. For example, this configuration can be explicit via a parameter (e.g. an RRC parameter). Or it can be implicit.

In one example, when implicit, it could be based on the value of K. For example, when K>1 CSI-RS resources, an PG or O-RU (or RU) corresponds to examples herein, and when K=1 CSI-RS resource, an PG or O-RU (or RU) corresponds to examples herein.

In another example, the configuration could be based on the configured codebook. For example, an PG or O-RU (or RU) corresponds to a CSI-RS resource (as in other examples herein) or resource group (A.3) when the codebook corresponds to a decoupled codebook (modular or separate codebook for each PG or O-RU (or RU)), and an PG or O-RU (or RU) corresponds to a subset (or a group) of CSI-RS ports (as in other examples herein) when codebook corresponds to a coupled (joint or coherent) codebook (one joint codebook across PGs).

In one example, when PG or O-RU (or RU) maps (or corresponds to) a CSI-RS resource or resource group (as in other examples herein), and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group (example A.4), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (as in other examples herein), a decoupled (modular) codebook is used/configured, and when a single (K=1) CSI-RS resource for N_{g} PGs (as in other examples herein), a joint codebook is used/configured.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

The channel measurement can be based on K≥1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

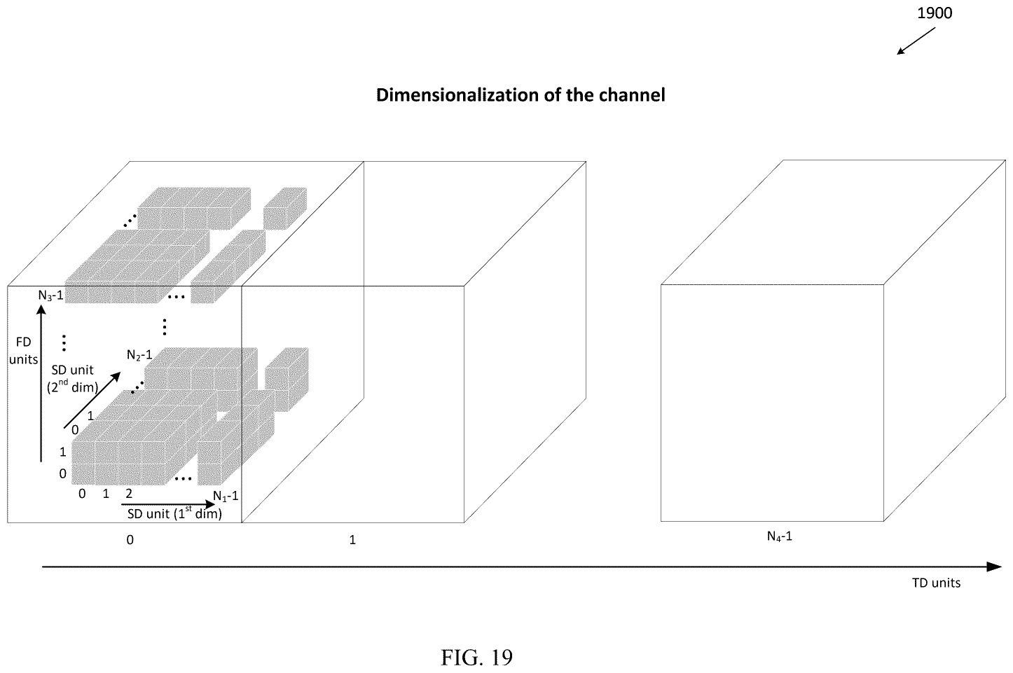

FIG. 19 illustrates an example of channel dimensionalization 1900 according to embodiments of the present disclosure. For example, the channel dimensionalization 1900 is one example of a channel in the network 100. This example is for illustration only and other embodiments can be used without departing from the scope of the present disclosure.

As illustrated in FIG. 19, channel dimensionalization 1900 includes SD units (in 1st and 2^{nd} antenna dimensions), FD units, and, and TD units. The first dimension is associated with the 1^{st} antenna port dimension and comprises N₁ units. The second dimension is associated with the 2^{nd} antenna port dimension and comprises N₂ units. The third dimension is associated with the frequency dimension and comprises N₃ units. The fourth dimension is associated with the time/Doppler dimension and comprises N₄ units.

Alternatively, the SD units, FD units, and, and TD units are as follows. The first dimension is associated with the antenna port dimension and comprises P_{CSIRS} units. The second dimension is associated with the frequency dimension and comprises N₃ units. The third dimension is associated with the time/Doppler dimension and comprises N₄ units.

Regarding SD units, the plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.

When N_{g}=1, there is one PG or O-RU (or RU) comprising all P_{CSIRS} ports, and the CSI report is based on the channel measurement from the one PG or O-RU (or RU).

When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG or O-RU (or RU) (one-to-one mapping). In one example, multiple CMRs can correspond to an PG or O-RU (or RU) (many-to-one mapping).

In one example, when all of the P_{CSIRS} antenna ports are co-located at one site, N_{g}=1. In one example, when all of the P_{CSIRS} antenna ports are distributed (non-co-located) across multiple sites, N_{g}>1.

In one example, when all of the P_{CSIRS} antenna ports are co-located at one site and within a single antenna panel, N_{g}=1. In one example, when all of the P_{CSIRS} antenna ports are distributed across multiple antenna panels (can be co-located or non-co-located), N_{g}>1.

The value of N_{g} can be configured, e.g. via higher layer RRC parameter. Or it can be indicated via a MAC CE. Or it can be provided via a DCI field.

Likewise, the value of K can be configured, e.g. via higher layer RRC parameter. Or it can be indicated via a MAC CE. Or it can be provided via a DCI field.

In one example, K=N_{g}=X. The value of X can be configured, e.g. via higher layer RRC parameter. Or it can be indicated via a MAC CE. Or it can be provided via a DCI field.

In one example, the value of K is determined based on the value of N_{g}. In one example, the value of N_{g} is determined based on the value of K

Regarding FD units, the plurality of FD units can be associated with a frequency domain allocation of resources (e.g. one or multiple CSI reporting bands, each comprising multiple PRBs) and dimensionalizes the frequency (or delay)-domain profile of the channel measurement.

Regarding TD/DD units, the plurality of TD units can be associated with a time domain allocation of resources (e.g. one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is P_{CSIRS,tot}=Eᵣ₌₁^{K}2N_{1,r}N_{2,r}.

In port numbering scheme 1, the CSI-RS ports are numbered according to the order of (polarization p, NZP CSI-RS resource r) as CSI-RS ports of (p=0,r=1) followed by CSI-RS ports of (p=1,r=1), followed by CSI-RS ports of (p=0,r=2), followed by CSI-RS ports of (p=1,r=2), . . . ,followed by CSI-RS ports of (p=0,r=N) followed by CSI-RS ports of (p=1,r=N).

In port numbering scheme 2, the CSI-RS ports are numbered according to the order of (polarization p, NZP CSI-RS resource r) as CSI-RS ports of (p=0,r=1) followed by CSI-RS ports of (p=0,r=1), . . . ,followed by CSI-RS ports of (p=0, r=N), and then CSI-RS ports of (p=1, r=1) followed by CSI-RS ports of (p=1,r=1), . . . ,followed by CSI-RS ports of (p=1, r=N).

In one example, an PG or O-RU (or RU) corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r1}=P_{CSIRS,r2} or P_{CSIRS,r1}+P_{CSIRS,r2}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₂})≠(N_{1,r}_{₂}, N_{2,r}_{₂}).

In one embodiment, for next generation MIMO systems (e.g. 6G), an PG or O-RU (or RU) based framework is used to support several advanced features such as the following.

In one example, a distributed NW topology is a key enabler considering new future market needs of the cellular industry (e.g. >52.6 GHz, upper mid-band, THz bands, mobility, duplexing, NES). It can support both legacy (cell-centric) NW as a specific configuration and new (cell-free/boundary-less or user-centric/beam-based) NW. In 3GPP, schemes for such NW topologies have been discussed/supported, e.g., dynamic point selection (DPS), coordinated scheduling/BF (CS/CB), NCJT, and CJT. These schemes are now feasible/implementable owing to disaggregated 5G RAN, i.e., distributing RAN functions into centralized unit (CU), distributed unit (DU), and radio unit (RU), and fast fronthaul solutions to connect the units, such as enhanced common public radio interface (eCPRI). Two new features have been adopted in the current release: dynamic TRP selection and enhanced Type-II CSI assuming CJT. These are crucial to improve spectral efficiency, especially in frequency bands with limited bandwidth. In high frequency bands (e.g. mmWave) also, due to large propagation loss and a (analog) beam-based air interface, the channel is likely to be sparse, implying that the distributed NW topology with frequent (analog) beam update is essential. It is also expected that new antenna architectures (e.g. non-uniform) will be relevant in 6G. As an example, a radio stripe system has been introduced for TDD systems wherein the antenna elements and associated processing units are integrated inside multiple connected radio stripes, and thereby, a flexible deployment to attach irregular surfaces becomes feasible. Also, another practical architecture for FDD was introduced, distributed massive MIMO using modular antenna structures, where several basic antenna modules are predefined, and any combination of them can flexibly be deployed and connected to form a single MIMO system. MIMO supporting such flexible antenna structures will require more advanced, modular, and scalable framework than that for 5G in order to ensure efficient communication between the NW and the user.

In one example, the most resource-efficient beam reporting is aperiodic (AP), in conjunction with aperiodic CSI-RS. Although a NW-triggered AP beam reporting is preferred, in some scenarios where the NW lacks knowledge on the DL channel condition or the user knows the DL channel condition better, it is clearly beneficial if AP beam reporting is user-initiated or event-driven. For instance, when the user is configured only with AP beam reporting and the channel condition is worsened to the point of beam failure, the loss of link due to beam failure can be avoided if the user can transmit the AP beam report without having to wait for a trigger from the NW. Likewise, the user can trigger a new beam switch without having to wait for a beam switch indication from the NW. This would also reduce overhead and latency significantly, especially in high mobility scenarios.

In one example, the ICBM-based mobility can be simplified to an PG or O-RU (or RU)-based mobility wherein PGs replace cells, and mobility essentially is handled by PG or O-RU (or RU) selection/update, i.e., moving from one set of PGs to another set. NES and advanced duplexing can also be supported based on dynamic PG or O-RU (or RU) assignment.

In one embodiment, an PG or O-RU (or RU) can be the basic NW entity (e.g. for 6G) since it can be an abstraction for antenna panel (N_{g}=1), TRP (N_{g}≥1), CSI-RS antenna ports of a NZP CSI-RS resource (N_{g}=1), a subset of CSI-RS antenna ports of a NZP CSI-RS resource (N_{g}≥1), CSI-RS antenna ports of multiple NZP CSI-RS resources comprising a CSI-RS resource set.

For a precoding/BF architecture, a SD precoding/BF can be used across antenna ports in order to achieve MIMO gains. Depending on the carrier frequency and the feasibility of RF/HW-related components, the SD precoding/BF can be fully-digital or hybrid analog-digital. In a fully-digital BF, there can be one-to-one mapping between an antenna port and an antenna element, or a ‘static/fixed’ virtualization of multiple antenna elements to one antenna port can be used. Since antenna port can be digitally controlled, a spatial multiplexing across all antenna ports is possible and the maximum possible MIMO gain can be achieved. For intra-PG or O-RU (or RU) precoding, N_{g}=1 and antenna ports belong to one PG or O-RU (or RU), and for inter-PG or O-RU (or RU) precoding, N_{g}>1 and antenna ports are aggregated across multiple PGs.

In a hybrid analog-digital BF, analog BF corresponds to a ‘dynamic/varying’ virtualization of multiple antenna elements to obtain one antenna port (or antenna panel), details as described above The spatial multiplexing gain is controlled by the number of antenna ports and the analog beam (phase shifters) at each antenna port. When an PG or O-RU (or RU) corresponds to Nₚₐₙₑₗ>1 antenna panels, P_{g}=Nₚₐₙₑₗs_{g}.

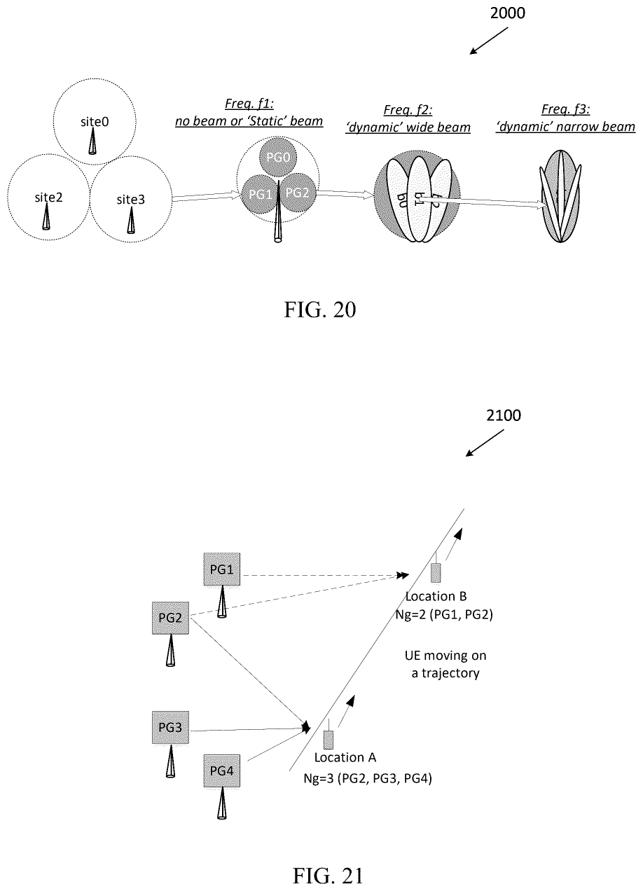

FIG. 20 illustrates an example of an analog beam-based NW topology 2000 according to embodiments of the present disclosure. For example, the analog beam-based NW topology 2000 can be utilized in the NW 100 of FIG. 1. This example is for illustration only and other embodiments can be used without departing from the scope of the present disclosure.

As illustrated in FIG. 20, a cellular region can be served by partitioning (or covering) the region into (with) multiple sites and deploying multiple PGs at each site. An example is illustrated in FIG. 20 there are three PGs per site. For a frequency f1 (e.g. in FR1), each PG or O-RU (or RU) is controlled by a fully-digital processing chain, implying there is no analog beam or a fixed beam, and all PGs at one site together can serve users belonging to the respective site. At a higher frequency f2 (e.g. in FR2), each PG or O-RU (or RU) is associated with a hybrid analog-digital structure, implying each antenna port of the PG or O-RU (or RU) needs to be assigned/updated with one of the three wide beams. At an even higher frequency, since analog beams get narrower (reduced beam-width), number of analog beams increases, hence antenna ports of an PG or O-RU (or RU) need to be assigned/updated with one of the nine narrow beams. In general, an PG or O-RU (or RU) can be assigned/updated with A_{g} analog beams. When A_{g}=1, there is one analog beam per PG or O-RU (or RU). When A_{g}-S_{g}, three is one analog beam per polarization per PG or O-RU (or RU). When A_{g}=Nₚₐₙₑₗ, there is one analog beam per antenna panel/port per PG or O-RU (or RU). When A_{g}=NₚₐₙₑₗS_{g}, there is one analog beam per polarization per antenna panel/port per PG or O-RU (or RU).

FIG. 21 illustrates an example of PG or O-RU (or RU)-based mobility 2100 according to embodiments of the present disclosure. For example, the PG or O-RU (or RU)-based mobility 2100 can be implemented in the NW 100 of FIG. 1. This example is for illustration only and other embodiments can be used without departing from the scope of the present disclosure.

In a mobility scenario, multiple PGs can serve a moving user. An illustration is shown in FIG. 21. While the user moves from a location A to another location B, the set of PGs is updated.

In one embodiment, parameters relevant for PGs are as tabulated in Table 1. Depending on carrier frequency, BF, and NW topology, the user can be configured with N_{g} PGs and values of relevant parameters. A few examples of the configuration are shown in Table 2. For Config 1,2,4, an PG or O-RU (or RU) can include two antenna ports/panels (S_{g}=2), and they can have the same analog beam.

TABLE 1

| | Values | |
|---|---|---|
| Parameters | Fully-digital | Hybrid BF |
| Number of PGs, N_{g} | {1, 2, 3, 4} | Number of panels, |
| | | Nₚₐₙₑₗ ∈ {1, 2, 4} |
| Number of ports per PG | {1, 2, 4, . . . , 256} | 1 |
| or O-RU (or RU), P_{g} | | |
| Number of beams per | 1 | 1 ≤ n_{b} ≤ 256 |
| port, N_{b} | | |
| FD granularity | T-F patterns, | WB |
| | repeats across | |
| TD granularity | RBs | Multiple symbols |
| | | (one per beam) |
| Density ρ (REs per RB) | {0.5, 1} | {1, 3} |
| Measurement | One-shot: AP | Beam-sweeping |
| | Multi-shot: P/SP | (symbol-level) |

TABLE 2

| Config | N_{g} | P_{g} | N_{b} | |
|---|---|---|---|---|
| 1 | ≥1 | 1 | 1 | |
| 2 | ≥1 | >1 | 1 | |
| 3 | ≥1 | n | n | P_{g} = N_{g} |
| 4 | m | l | m | N_{g} = N_{b} |
| 5 | m | n | mn | N_{g}P_{g} = N_{b} |

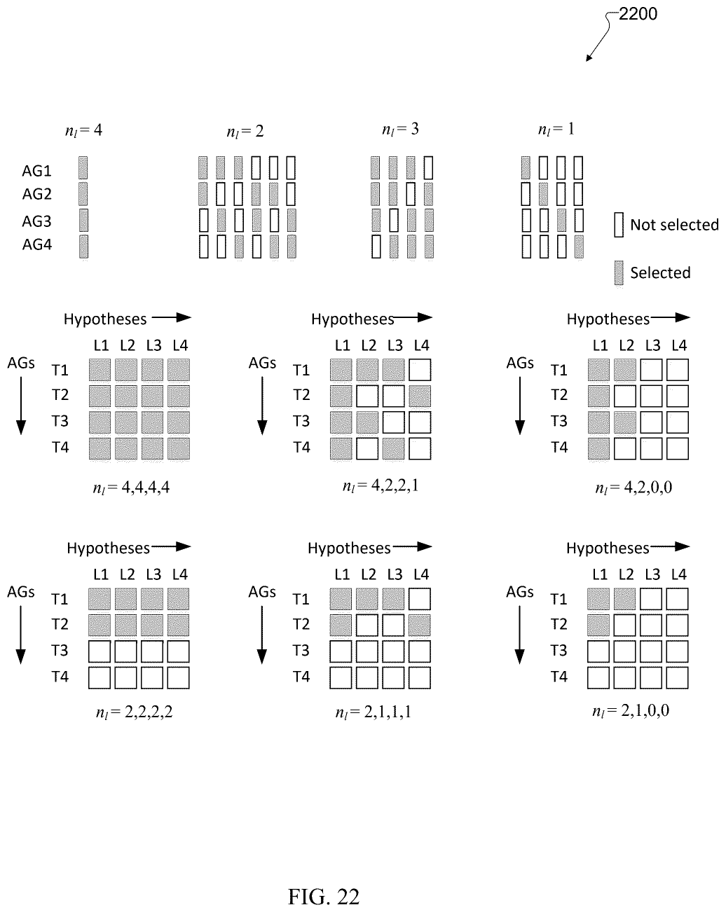

FIG. 22 illustrates an example of PG or O-RU (or RU) selection hypotheses 2200 according to embodiments of the present disclosure. For example, the PG or O-RU (or RU) selection hypotheses 2200 can be implemented in the NW 100 of FIG. 1. This example is for illustration only and other embodiments can be used without departing from the scope of the present disclosure.

The example PG or O-RU (or RU) selection hypotheses 2200 are for N_{g}=4 and Y≤4. In one embodiment, a user is configured with a dynamic MIMO framework based on two components: 1) PG or O-RU (or RU) adaptation/selection and common long-term stats and assumptions, and 2) fast and accurate CSI acquisition. The two components can be together/joint or decoupled. When latter, 2) can be based on (conditional on) 1).

Various embodiments of the present disclosure relate to PG or O-RU (or RU) selection. Let Y≥1 be a number of PG or O-RU (or RU) selection hypotheses. For each l ∈{1, . . . , Y}, an PG or O-RU (or RU) selection hypothesis selects nᵢ PGs, where 1≤nᵢ≤NAG. The PG or O-RU (or RU) selection can either be user-reported (performed by the user, and reported to the NW), or NW-controlled (performed by the NW, and indicated to the user), and can either be a standalone/separate or a non-standalone procedure. When non-standalone, the PG or O-RU (or RU) selection can be included or/and multiplexed either with a DL indication such as beam or TCI state indication, or with a report (e.g. CSI or beam report). When user-reported, the PG or O-RU (or RU) selection report includes an information about the selected {nₗ} PGs, and can also include a metric (e.g. RSRP, power level, SINR). The PG or O-RU (or RU) selection is signaled dynamically, e.g., via a MACE CE or a DCI or a DCI with MAC CE activation (similar to beam/TCI state indication) or via UCI (similar to aperiodic beam/CSI report). Note that the PG or O-RU (or RU) selection can support both NW-controlled features such as beam (TCI state) indication, TRP indication (CJT), port indication (non-PMI feedback), sub-configurations (NES), and SBFD (duplexing); and User-reported features such as dynamic TRP selection (CJT), dynamic port selection (PS T2 codebook).

Various embodiments of the present disclosure relate to common long-term (LT) stats/assumptions. For Quasi co-location (QCL) assumptions between PGs, a QCL relationship corresponds to LT channel properties that the user can assume to be the same/common across antenna ports associated with PGs. Relevant LT channel properties include:
Angular profile: spatial filter parameter (analog beam),
Delay profile: average delay, delay spread, and
Doppler profile: Doppler shift, Doppler spread.

A QCL relation can include one or multiple of LT channel properties, and a few types of QCL relations are as follows:
Doppler shift, Doppler spread, average delay, delay spread,
Doppler shift, Doppler spread,
Doppler shift, average delay, and
Spatial filter parameter.

Regarding coherency assumptions between PGs, the coherency can be (1) full-coherence (FC), a layer (stream) can be transmitted using all antenna ports, (2) partial-coherence (PC), i.e., a layer (stream) can be transmitted using at least two but not all antenna ports, or (3) non-coherence (NC), i.e., a layer (stream) can be transmitted using one antenna port.

For antenna ports within an PG or O-RU (or RU), LT channel properties (QCL and coherency) remain the same, and for antenna ports across PGs, LT channel properties (QCL and coherency) can be different.

In various embodiments, the CSI for the selected PGs can be configured based on the following:
Number of analog beam: when Np=1, antenna ports within an PG or O-RU (or RU) are FC and antenna ports across multiple PGs can be FC/PC/NC, and when Np>1, antenna ports within an PG or O-RU (or RU) can be FC/PC/NC and antenna ports across multiple PGs are NC.
Report quantity 1 (beam-related CSI):
   PG or O-RU (or RU)-common hypotheses: Y hypotheses are common for all PGs.
   PG or O-RU (or RU)-specific hypotheses: Y=Σ_{g=1}^{N}^{_{g}}, Y_{g} and Y_{g} is number of hypotheses for PG or O-RU (or RU) g.
Report quantity 2 (non-beam-related CSI):
   Multiple CSI hypotheses: CSI for one of or a subset of or all of Y hypotheses
   Layer-common hypothesis: Y=1
   Layer-specific hypothesis: Y=ν (number of layers)
Report quantity 3 (both beam-related and non-beam-related CSI):
   Combinations of above

In one embodiment for non-beam-related CSI, at a low speed, Type II CSI shows large performance gain over Type I CSI. As speed increases, the performance of Type II CSI starts to deteriorate at a faster rate than that of Type I. After a certain speed, the performance of Type II CSI becomes worse than Type I CSI. NW can alleviate this loss in performance at higher speed (e.g. based on UL channel measurement), but it consumes UL resources and may still not work for far (cell-edge) users. A superior scheme can be based on dynamic selection of a value for L (e.g. from {1,2,3,4}) and corresponding L SD vectors. When L=1 is selected, Type I CSI is reported, and when L>1, enhanced Type II CSI is reported.

In one embodiment for beam-related CSI, in a beam-based air interface, multiple users can be served based on MU-MIMO or SDMA. For MU-MIMO, NW needs to perform joint scheduling of (user, beam) combinations. For SDMA, antenna ports (beams) need to be partitioned among scheduled users. When two users have the same optimal beams for the different RF chains, the MU interference can be very severe. To reduce MU interference, only a subset of antenna ports can be assigned for MU-MIMO, and the rest of the antenna ports can be assigned to a single user or multiple SDMA users. To achieve a tradeoff between interference and MU gains, a hybrid scheme is provided which combines SDMA and MU-MIMO. A subset of antenna ports with close beams is selected for MU-MIMO and the rest of the antenna ports is used for SDMA, where the ‘close’ beams are based on comparing the correlation coefficient of two analog BF weights with a threshold. After SDMA and MU-MIMO antenna ports are identified, scheduling is performed independently within the two sets of antenna ports. Since two sets of antenna ports are for different schemes, precoder needs to be calculated independently for the two. Finally, the precoders are normalized based on the number of the antenna ports for SDMA and MU-MIMO. The NW can request a beam report from the scheduled users for the scheduled beams to assist scheduling and improve performance.

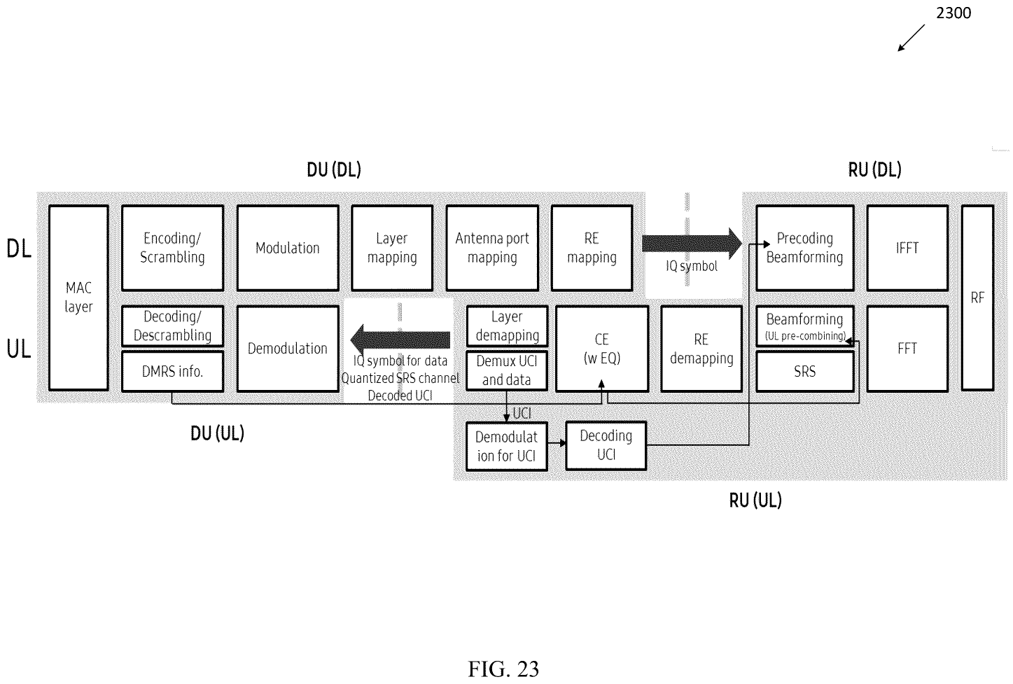

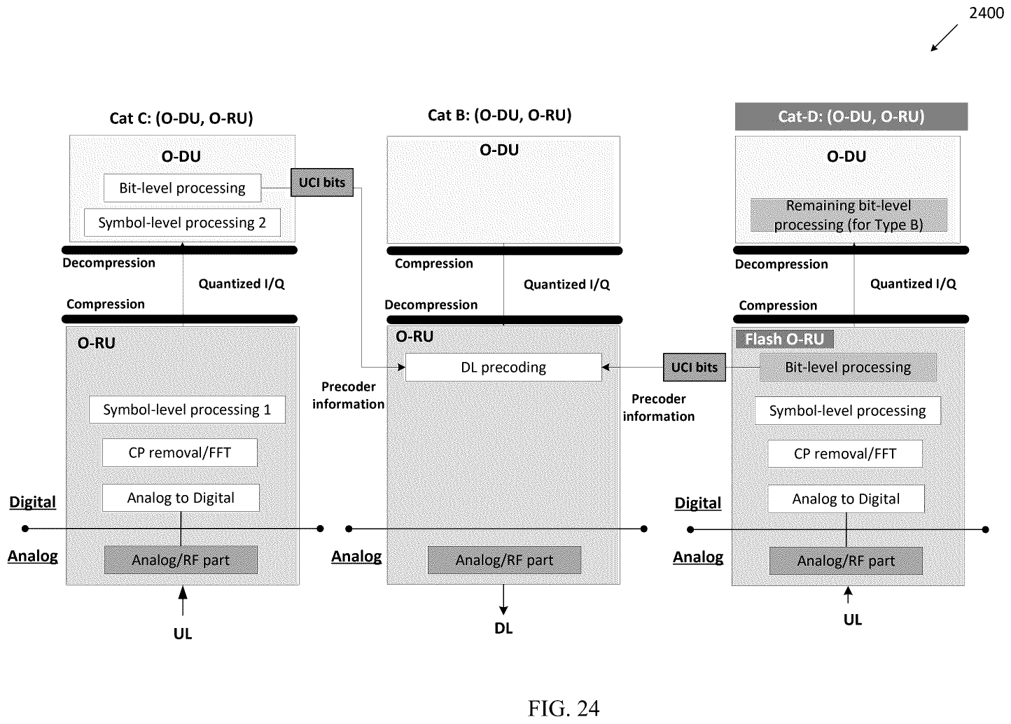

FIG. 23 illustrates a diagram of an example functional split 2300 between a DU an RU for uplink and downlink communications according to embodiments of the present disclosure and FIG. 24 illustrates a diagram 2400 for an example comparison between O-RAN Cat-C and the flash O-RU (Cat-D split) according to embodiments of the present disclosure. For example, the functional split 2300 and the Cat-D split can be implemented in a base station such as the BS 102 of FIG. 2. These examples are for illustration only and other embodiments can be used without departing from the scope of the present disclosure.

In one embodiment, an advanced O-RU that is capable of UCI decoding for CSI (or at least PMI) is provided for MIMO operations in an O-RAN based NW architecture. The resultant UL PHY split (namely Cat-D) is shown in FIG. 23, where the O-RU, named as flash O-RU, is capable of performing bit-level processing at least for UCI bits, in particular when the UCI carries CSI (including PMI). The comparison between O-RAN Cat-C and the flash O-RU (Cat-D split) is shown in FIG. 24.

For a MIMO operation utilizing multiple O-RUs (e.g. CJT), at least one of the multiple O-RUs can be a flash O-RU and the multiple O-RUs can be connected to this flash O-RU. The PMI(s) of a few candidate UEs can be processed/stored/shared among relevant O-RUs. Depending on the scheduling information, precoders can be calculated and applied at respective O-RU(s).

In one embodiment, a UE is configured to transmit UL transmission and at the NW-side, one or more than PG(s) or O-RU(s) receives the UL transmission, where the UL transmission includes channel/signal and/or information such as UCI.

In one example, the UL transmission includes UCI only. In this case, the UL channel can be PUCCH. Or the UL channel can be PUSCH.

In one example, the UL transmission includes UCI with CSI (or at least PMI). In this case, the UL channel can be PUCCH. Or the UL channel can be PUSCH.

In one example, the UL transmission includes UCI and UL data. In this case, the UL channel can be PUCCH or/and PUSCH. In one example, UCI includes CSI (or at least PMI).

In one example, the UCI can be a one-part UCI. In one example, the UCI can be a two-part UCI (UCI part 1 and UCI part 2).

In one example, the UL transmission includes one CW. In one example, the UL transmission includes more than one (e.g. two) CWs.

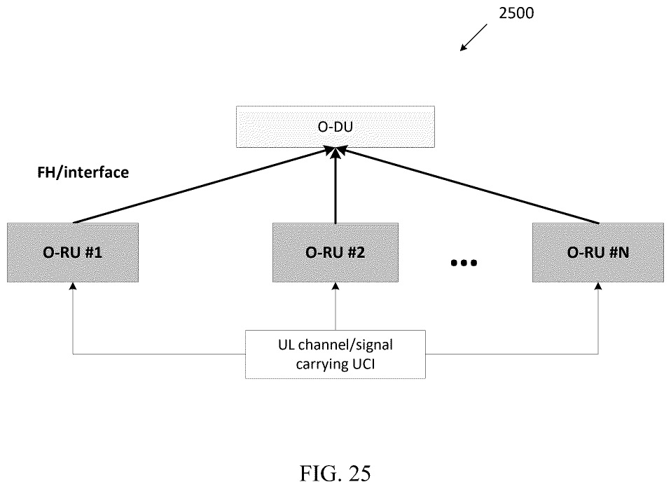

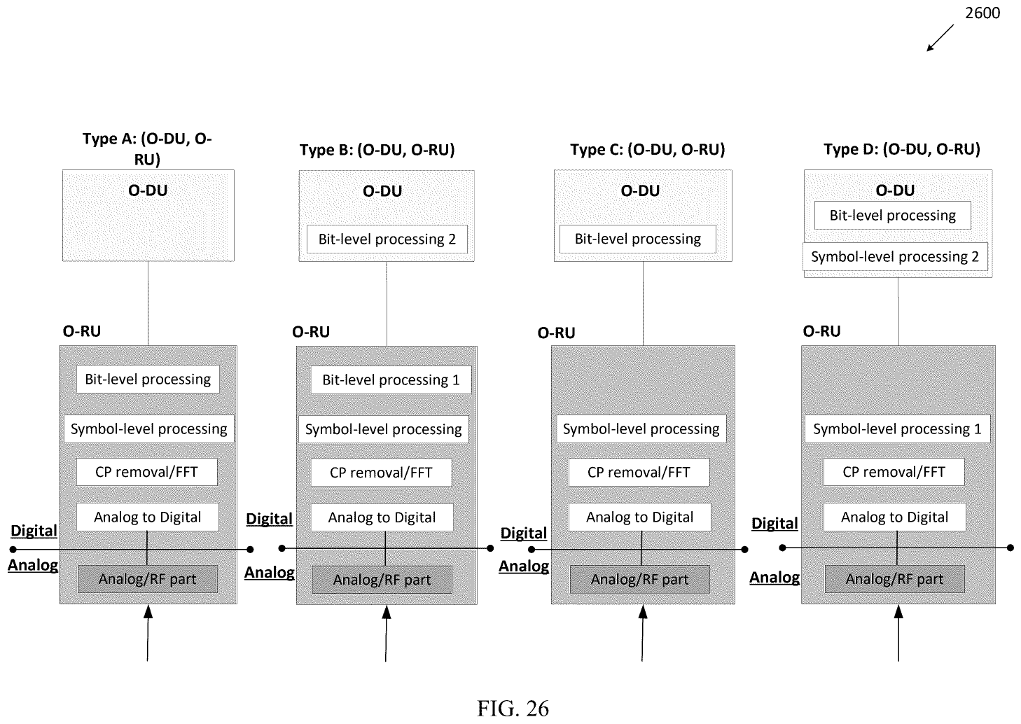

FIG. 25 illustrates a diagram of an example functional split 2500 for processing an UL transmission according to embodiments of the present disclosure and FIG. 26 illustrates four examples of types 2600 of functional splits for processing of the UL transmission. For example, the functional split 2500 and four example types 2600 of functional splits can be implemented in a base station such as the BS 102 of FIG. 2. These examples are for illustration only and other embodiments can be used without departing from the scope of the present disclosure.

As illustrated in FIG. 25, in one embodiment, the functional split for processing the UL transmission is as shown, where O-RUs are according to one of the four types shown in FIG. 26 or a flash O-RU. When N>1:
In one example, all O-RUs are of the same type (e.g., type A or B or D or flash O-RU).
In one example, a subset of O-RUs can be of one type (e.g. A or B or flash O-RU), and remaining of another type (e.g., type D).
In one example, one O-RU can be of one type (e.g., type A or B or flash O-RU), and remaining N-1 O-RUs of another type (e.g., type D).
In one example, one O-RU can be of one type (e.g., type A or flash O-RU), and remaining N-1 O-RUs of another type (e.g., type B).
In one example, the type of each of the N O-RUs can be configured/controlled by the O-DU (e.g., via a control plane message or a management plane message).
In one example, the type of each of the N O-RUs can depend on the type of the UCI type. For example, when UCI includes CSI (at least PMI), at least one O-RU is a flash O-RU, else (when UCI does not include CSI), none all O-RUs are flash O-RUs (or Type A or Type B O-RUs).

In one embodiment, the UCI includes CSI only.

For Type B O-RUs, the bit-level processing 1 can correspond to PMI, and the bit-level processing 2 can corresponding to the rest of the CSI (e.g. RI/CQI/CRI/LI or/and beam related CSI, e.g. CRI/SSBRI+L1-RSRP/SINR).

For Type B O-RUs, the bit-level processing 1 can correspond to first stage (W1) of a multi-stage PMI (e.g. two-stage W1,W2), and the bit-level processing 2 can corresponding to remaining stage (e.g. W2) of the multi-stage PMI and the rest of the CSI (e.g. RI/CQI/CRI/LI or/and beam related CSI, e.g. CRI/SSBRI+L1-RSRP/SINR).

For Type B O-RUs, the bit-level processing 1 can correspond to second stage (W2) of a two-stage PMI (W1,W2), and the bit-level processing 2 can corresponding to first stage (W1) of the two-stage PMI and the rest of the CSI (e.g. RI/CQI/CRI/LI).

For Type B O-RUs, the bit-level processing 1 can correspond to CW1 (e.g. UCI1 or a part of UCI) included CW1, and the bit-level processing 2 can corresponding to CW2 (e.g. UCI2 or a part of UCI).

For Type B O-RUs, the bit-level processing 1 can correspond to CSI part 1 (e.g. UCI1 or a part of UCI) included CW1, and the bit-level processing 2 can corresponding to CSI part 2 (e.g. UCI2 or a part of UCI).

For Type B O-RUs, the bit-level processing 1 can correspond to CSI (e.g. UCI1 or a part of UCI) included CW1, and the bit-level processing 2 can corresponding to at least one of HARQ-ACK/NACK, SR, UCI other than CSI (e.g. UCI2 or a part of UCI).

In one embodiment, the UCI includes CSI (at least PMI), and at least one of HARQ-ACK/NACK, SR, UCI other than CSI, where the CSI and its functional split is according to one of the example above. At least one of the following examples is used or configured.

In one example, the UCI includes CSI (at least PMI), and HARQ-ACK/NACK.

In one example, the UCI includes CSI (at least PMI), and SR.

In one example, the UCI includes CSI (at least PMI), and UCI other than CSI.

In one example, the UCI includes CSI (at least PMI), HARQ-ACK/NACK, and SR.

In one example, the UCI includes CSI (at least PMI), HARQ-ACK/NACK, and UCI other than CSI.

In one example, the UCI includes CSI (at least PMI), SR, and UCI other than CSI.

In one example, the UCI includes CSI (at least PMI), HARQ-ACK/NACK, SR, and UCI other than CSI.

In one embodiment, the DL scheduling SU/MU (across O-RUs, and/or PRBs/SBs) is conveyed and provided via the fronthaul (FH) from O-DU to O-RU(s), and each of the O-RU(s) determine their precoders (SU or MU such as SLNR or zero-forcing) for DL precoding according to the scheduling (per O-RU).

In one embodiment, each O-RU is provided with (hence stores) PMIs of a set of candidate users that can be co-scheduled (served) by the UE). This (PMIs) information can be provided by the O-DU (via FH). Or, in case of flash O-RU, the flash O-RU decodes the UCI carrying PMI(s), and shares the relevant PMI(s) to each of the multiple O-RUs. This sharing for instance can be via a. inter-O-RU direct communication link (as described below).

In one example, the scheduling is performed by the O-DU and the scheduling information is provided to the respective O-RUs (via FH). Each O-RU uses the stored PMIs of the set of candidate users that can be co-scheduled, to calculate SU or MU precoder (based on the scheduling).

In one embodiment, for a flash O-RU and functional split (Cat-D), wherein O-RU is capable to perform bit-level processing to extract UCI bits, at least the following aspects are provided to enable such bit-level processing:
Channel coding/decoding is based one of polar and LDPC channel coding schemes. In one example, the coding/decoding is based a polar coding schemes (for UCI bits since it has a lower error floor than LDPC). However, the decoding complexity and latency of polar codes can be large. In one example, to overcome these, the polar codes can be enhanced for UCI bits with the goal to reduce complexity and latency. For instance, a code block (CB) segmentation (>2 CBs) can be provided for such an enhancement. Also, a belief propagation-based decoding is provided.
PMI payload size: the maximum PMI payload is expected to be in 1000s of bits (e.g. ˜ 2000 bits for CJT). This value is expected to increase further in future due to increased number of digital ports (e.g. up to 256).

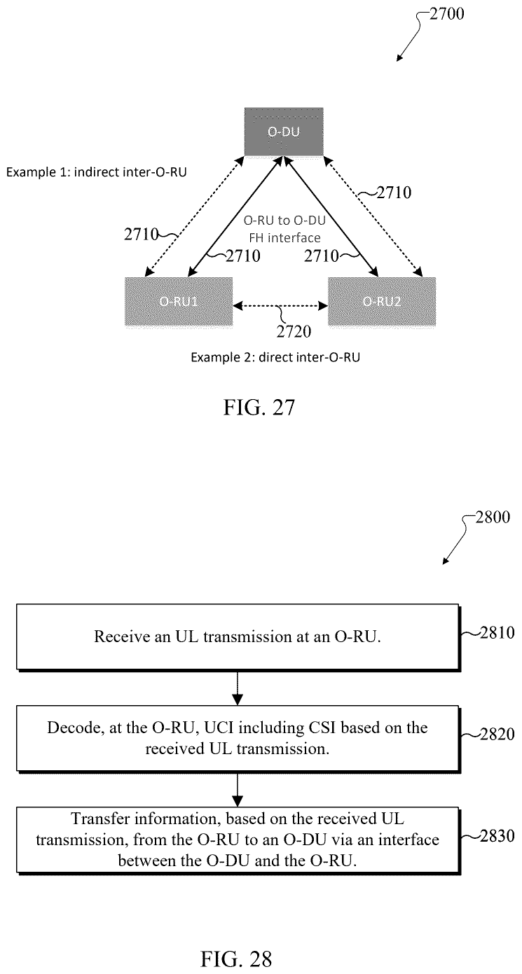

FIG. 27 illustrates a diagram of example inter O-RU direct access/communication links 2700 according to embodiments of the present disclosure. For example, the inter O-RU direct access/communication links 2700 can be implemented among RUs and a DU in a base station such as the BS 102 of FIG. 2. This example is for illustration only and other embodiments can be used without departing from the scope of the present disclosure.

In Cat-B/C split, the UCI bit processing and scheduling are performed in O-DU, but the pre-coding is performed in O-RU(s). This requires (i) passing the UL information (quantized I/Q samples or SRS measurements) from O-RU(s) to O-DU, (ii) UCI bit processing to obtain PMI (in case of PMI-based pre-coding) and (iii) providing the scheduling and precoding related information (e.g. PMIs of the co-scheduled users or MU pre-coder) to the corresponding O-RU(s). This communication happens via O-RU to O-DU FH interfaces 2710, which can be wired or wireless communication links.

Additionally, for inter-O-RU communication, an additional large delay is expected when O-RU1 communicates with O-RU2 via O-DU(s) (e.g., example 1 in FIG. 27), considering current implementation, e.g. O-RU1->0-DU1->0-DU2->0-RU2 or O-RU1->0-DU->O-RU2. This is due to security procedures required to access other O-DU or channel card (interface to connect), hence incurring long latency.

Additionally, for an inter-O-RU transmission scheme such as CJT or interference coordination/avoidance, there is a need to support an O-RU to O-RU (inter-O-RU) direct access/communication link 2720 in order to exchange relevant information without having to go through the O-DU (e.g., example 2 in FIG. 27). With such a communication link, the CJT performance can be achieved even with at least one flash O-RU and remaining O-RAN O-RUs. This direct link can be a FH a wired (optical fiber) interface or a side-haul interface (a new interface), or over-the-air (OTA). In case of the former, however, the impact of FH compression is not be ignored, especially when SRS channel measurement needs to be communicated between O-RUs.

In one embodiment, when there are multiple O-RUs (e.g. connected to the same O-DU via the FH interface), the NW (e.g. gNB or O-CU or O-DU or similar entity) can include/provide (or benefit from) an advanced inter-O-RU direct access link (e.g. over-the-air (OTA) or optical fiber, or another link) to facilitate communication between the flash O-RU and the other O-RUs, or between multiple O-RUs, this direct link is instrumental. Such links can provide direct access for information exchange between O-RUs, without having to go through the O-DU, for instance, to exchange scheduling and precoding information.

Various embodiments of the present disclosure provide for high-complexity operations in O-RU. In one embodiment, the NW (e.g. gNB or O-CU or O-DU or similar entity) can include/provide (or benefit from) a having/keeping high-complexity operations on O-RU (instead of O-DU). In one example, an SVD-processor/accelerator is one such high-complexity operation. In a massive MIMO setup, where PMI-based DL precoding is utilized, as the number of CSI-RS ports increases, the increase in DL measurement overhead surpasses the UPT gain from increasing the number of ports. Thus, there is a preferred or optimal value of number of CSI-RS ports (e.g. 64) beyond which the UPT starts to decrease. This entails to an increasingly large gap between PMI-based and (ideal) SRS-based (SVD-based) DL precoding schemes. Therefore, in general whenever DL/UL reciprocity is available, SRS-based DL precoding can be used. With SRS, an SVD-based DL precoder achieving high-resolution MIMO performance can be feasible if an SVD processor (e.g., in processor 225 of BS 102) can be implemented in O-RUs to avoid quantization error due to information transfer via the FH. Furthermore, an SVD processor enabled to perform SVD with the total spatial dimensions across all O-RUs is beneficial. For instance, such SVD processor (e.g., in processor 225 of BS 102) can be capable for XY ports for X O-RUs with Y ports per each of O-RUs, so that each O-RU can calculate its CJT precoder for the XY-port aggregated channel response. In one example, X ∈{1,2,3,4}. In one example, Y=32 or Y>32.

FIG. 28 illustrates an example method 2800 performed by a BS in an O-RAN architecture according to embodiments of the present disclosure. The method 2800 of FIG. 28 can be performed by any of the BSs 101-103 of FIG. 1, such as the BS 102 of FIG. 2. The method 2800 is for illustration only and other embodiments can be used without departing from the scope of the present disclosure.

The method 2800 begins with the BS receiving receive an UL transmission at an O-RU of the BS (2810). In some embodiments, the UL transmission includes the UCI only and the UCI carries the CSI only. In some embodiments, the UL transmission includes the UCI and UL data.

The BS then decodes, at the O-RU, UCI including CSI based on the received UL transmission (2820). For example, in 2820, the CSI includes at least a PMI. In various embodiments, the O-RU performs bit-level processing to extract information bits from the UCI and the bit-level processing includes channel decoding based on polar or low density parity check (LDPC) channel coding and decoding schemes.

The BS then transfers information, based on the received UL transmission, from the O-RU to an O-DU via an interface between the O-DU and the O-RU (2830). For example, in 2830, the interface is a FH. In various embodiments, the O-DU hosts a high-PHY layer, the O-RU hosts a low-PHY layer and RF processing, and the low-PHY and high-PHY layers are based on a lower layer functional split of PHY layer baseband functionalities.

In various embodiments, the UCI is a first part of a two-part UCI, and the O-DU decodes a second part of the two-part UCI based on the information. For example, the first part and the second part of the two-part UCI may include at least one of: a first PMI and a second PMI, respectively, a first CW and a second CW, respectively, PMI and remaining components of the CSI, respectively, a CSI part 1 and a CSI part 2, respectively, of the CSI, and the CSI and at least one of a HARQ-ACK, a NACK, and a SR, respectively.

In various embodiments, the BS further includes multiple O-RUs, each connected to the O-DU, and an inter-O-RU direct access link to facilitate communication between the multiple O-RUs. In various embodiments, the O-RU includes an SVD processor for determining SVD-based precoding.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) in an open radio access network (O-RAN) architecture, the BS comprising:
an O-RAN distributed unit (O-DU) hosting a high-physical (PHY) layer, and
an O-RAN radio unit (O-RU) operably coupled with the O-DU, the O-RU hosting a low-PHY layer and radio frequency (RF) processing,
wherein the O-RU comprises:
a transceiver configured to receive an uplink (UL) transmission, and
a processor operably coupled with the transceiver, the processor configured to decode, based on the received UL transmission, uplink control information (UCI) including channel state information (CSI), and
wherein the low-PHY and high-PHY layers are based on a lower layer functional split of PHY layer baseband functionalities.

2. The BS of claim 1, wherein the CSI includes at least a precoding matrix indicator (PMI).

3. The BS of claim 1, wherein:
the processor of the O-RU, based on the received UL transmission, is further configured to transfer information to the O-DU via an interface between the O-DU and the O-RU, and
wherein the interface is a fronthaul (FH).

4. The BS of claim 3, wherein:
the UCI is a first part of a two-part UCI, and
a processor of the O-DU, based on the information, is further configured to decode a second part of the two-part UCI.

5. The BS of claim 4, wherein the first part and the second part of the two-part UCI include at least one of:
a first precoding matrix indicator (PMI) and a second PMI, respectively,
a first codeword (CW) and a second CW, respectively,
PMI and remaining components of the CSI, respectively,
a CSI part 1 and a CSI part 2, respectively, of the CSI, respectively, and
the CSI and at least one of a hybrid automatic repeat request acknowledgement (HARQ-ACK), a negative acknowledgement (NACK), and a scheduling request (SR), respectively.

6. The BS of claim 1, wherein the UL transmission includes the UCI only and the UCI carries the CSI only.

7. The BS of claim 1, wherein the UL transmission includes the UCI and UL data.

8. The BS of claim 1, wherein:
the processor of the O-RU is configured to perform bit-level processing to extract information bits from the UCI, and
the bit-level processing includes channel decoding based on polar or low density parity check (LDPC) channel coding and decoding schemes.

9. The BS of claim 1, wherein the BS further comprises:
multiple O-RUs, each connected to the O-DU, of which the O-RU is one, and
an inter-O-RU direct access link to facilitate communication between the multiple O-RUs.

10. The BS of claim 1, wherein the processor of the O-RU includes a singular value decomposition (SVD) processor for determining SVD-based precoding.

11. A method performed by a base station (BS) in an open radio access network (O-RAN) architecture, the method comprising:
receiving, by an O-RAN radio unit (O-RU) hosting a low-physical (PHY) layer and radio frequency (RF) processing, an uplink (UL) transmission; and
decoding, based on the received UL transmission, uplink control information (UCI) including channel state information (CSI),
wherein the BS further includes an O-RAN distributed unit (O-DU) operably coupled with the O-RU, the O-DU hosting a high-PHY layer, and
wherein the low-PHY and high-PHY layers are based on a lower layer functional split of PHY layer baseband functionalities.

12. The method of claim 11, wherein the CSI includes at least a precoding matrix indicator (PMI).

13. The method of claim 11, further comprising:
transferring, based on the received UL transmission, information to the O-DU via an interface between the O-DU and the O-RU, and
wherein the interface is a fronthaul (FH).

14. The method of claim 13, wherein:
the UCI is a first part of a two-part UCI, and
the method further comprises decoding, by the O-DU based on the information, a second part of the two-part UCI.

15. The method of claim 14, wherein the first part and the second part of the two-part UCI include at least one of:
a first precoding matrix indicator (PMI) and a second PMI, respectively,
a first codeword (CW) and a second CW, respectively,
PMI and remaining components of the CSI, respectively,
a CSI part 1 and a CSI part 2, respectively, of the CSI, respectively, and
the CSI and at least one of a hybrid automatic repeat request acknowledgement (HARQ-ACK), a negative acknowledgement (NACK), and a scheduling request (SR), respectively.

16. The method of claim 11, further comprising:
performing, by the O-RU, bit-level processing to extract information bits from the UCI,
wherein the bit-level processing includes channel decoding based on polar or low density parity check (LDPC) channel coding and decoding schemes.

17. The method of claim 11, wherein the BS further comprises:
multiple O-RUs, each connected to the O-DU, of which the O-RU is one, and
an inter-O-RU direct access link to facilitate communication between the multiple O-RUs.

18. The method of claim 11, wherein the O-RU includes a singular value decomposition (SVD) processor for determining SVD-based precoding.

19. A user equipment (UE) communicating with a base station (BS) in an open radio access network (O-RAN) architecture, the UE comprising:
a transceiver configured to receive information about uplink control information (UCI) including channel state information (CSI); and
a processor operably coupled with the transceiver, the processor configured to
determine the CSI, and
encode the UCI, the UCI including the CSI,
wherein the transceiver is further configured to transmit an uplink (UL) transmission including the UCI, and
wherein the BS comprises an O-RAN distributed unit (O-DU) hosting a high-physical (PHY) layer and an O-RAN radio unit (O-RU) operably coupled with the O-DU, the O-RU hosting a low-PHY layer and radio frequency (RF) processing,
wherein the low-PHY and high-PHY layers are based on a lower layer functional split of PHY layer baseband functionalities, and
wherein the O-RU decodes the UCI carrying the CSI.

20. The UE of claim 19, wherein the CSI includes at least a precoding matrix indicator (PMI).
